(19) United States
(12) Patent Application Publication
(10) Pub. No.: US 2010/0254284 A1
(43) Pub. Date: Oct. 7, 2010

(54) COMMUNICATION METHOD AND COMMUNICATION SYSTEM USING THE METHOD

(76) Inventors: Yoshiyuki Otani, Gifu (JP); Kiyoshige Ito, Gifu (JP)

Correspondence Address: MCDERMOTT WILL & EMERY LLP, 600 13TH STREET, N.W., WASHINGTON, DC, 20005-3096, US

(21) Appl. No.: 12/596,295

(22) PCT Filed: Apr. 15, 2008
(86) PCT No.: PCT/JP2008/000990

§ 371 Date: Jun. 17, 2010

(30) Foreign Application Priority Data
Apr. 16, 2007 (JP) 2007-107232

(51) Int. Cl. H04L 12/28

(52) U.S. Cl. 370/254

(57) ABSTRACT

In a communication system 100 formed by multiple terminal apparatuses 10, any one of the multiple terminal apparatuses 10 is selected to have the role of approving the participation of a new terminal apparatus 10. The participation of a new terminal apparatus 10 is approved by the selected terminal apparatus 10. Communication is performed in the communication system 100 while including the new terminal apparatus that has been approved to participate. A terminal apparatus 10 to be selected is switched among the multiple terminal apparatuses 10.

### TECHNICAL FIELD

The present invention relates to communication technology and particularly to a communication method in an ad hoc network and to a communication system using the communication method.

### BACKGROUND ART

An ad hoc network does not depend on any base station apparatus or wired network and is an autonomous distributed network including a terminal apparatus as a constituent element. In an ad hoc network, terminal apparatuses are equal to one another, and information exchange is carried out by implementing multi-hop networking. Routing methods for such ad hoc networks include a table driving method, an on-demand method, and a hybrid method. In a table driving method, each terminal apparatus holds a routing table storing the destination of a packet signal in relation with a next-hop destination. The terminal apparatus also determines the next-hop destination from the destination of a packet signal by referring to the routing table. The routing table is periodically updated by a control packet signal. Examples of a table driving method include DSDV (Destination Sequence Distance Vector), WRP (Wireless Routing Protocol), CGSR (Clusterhead Gateway Switch Routing), and OLSR (Optimized Link State Routing).

In an on-demand method, a terminal apparatus of information generation source finds a route to a destination when requesting the transfer of a packet signal. The terminal apparatus of information generation source learns a reverse route to the terminal apparatus of information generation source by transferring a packet signal for inquiry by using a flooding method, and a destination terminal apparatus that has received the packet signal for inquiry responds. Based on a route found in such a manner, a packet signal is transferred from a terminal apparatus of a generation source to a destination terminal apparatus. Examples of an on-demand method include AODV (Ad hoc On demand Distance Vector), DSR (Dynamic Source Routing), TORA (Temporally Ordered Routing Algorithm), RDMAR (Relative Distance Micro-discovery Ad hoc Routing Protocol), and ABR (Associativity-Based Routing). A hybrid method is a combination method of the table driving method and the on-demand method (for example, see non-patent document 1).

In an ad hoc network, a technique has been suggested for simplifying the settings of terminal apparatuses. A predetermined terminal apparatus retains communication setting information, and a tag is held over near an IC card reader/writer mounted on the terminal apparatus. As a result, by having noncontact communication with a tag, the IC card reader/writer transmits the communication setting information. By performing in reverse the above-stated procedure between the tag and an IC card reader/writer mounted on another terminal apparatus, the communication setting information is transmitted to the terminal apparatus (for example, see non-patent document 1).

[Non-Patent document No. 1] Kenichi Mase, Keisuke Nakano, Masakazu Sengoku, Shoji Shinoda, “Ad-hoc network,” The Journal of the Institute of Electronics, Information and Communication Engineers, Japan, The Institute of Electronics, Information and Communication Engineers, February 2001, Vol. 84, No. 2, pp.127-134.

[Patent document No. 1] JP 2004-7351

### DISCLOSURE OF INVENTION

### Technical Problem

In consideration of being user friendly, the procedure of a terminal apparatus for connecting to an ad hoc network is desirably simple. On the other hand, since an ad hoc network is formed by a plurality of terminal apparatuses, security measures are necessary in consideration of the influence on other terminal apparatuses. In order to improve the security, a role of approving the participation of a new terminal apparatus in the ad hoc network is assigned to any one of the plurality of terminal apparatuses forming the ad hoc network (hereinafter, the terminal apparatus to which the role is assigned is referred to as a “registrar”). In order to improve the simplicity of the connecting procedure, the connecting procedure is performed when a button provided to a new terminal apparatus is pushed down within a predetermined period after a button provided to the registrar is pushed down.

In this background, the inventor has come to realize the following problem. In general, the configuration of an ad hoc network keeps changing due to a terminal apparatus forming the ad hoc network leaving the network or a new terminal apparatus joining the network. When a terminal apparatus serving as a registrar leaves the ad hoc network, participation of a new terminal apparatus is not approved. Thus, a new terminal apparatus cannot participate in the ad hoc network or a new terminal apparatus must participate in the ad hoc network without approval. As a result, at least either security or the simplicity of connecting procedure cannot be achieved.

In this background, a general purpose of the present invention is to provide a communication technique for performing an approval process even when the configuration of an ad hoc network changes.

### Means for Solving the Problem

In order to solve the problem, a communication method according to one embodiment of the present invention comprises: selecting, in an ad hoc network formed by a plurality of terminal apparatuses, any one of the plurality of terminal apparatuses to have the role of approving the participation of a new terminal apparatus in the ad hoc network; approving the participation of a new terminal apparatus by the selected terminal apparatus; and communicating in the ad hoc network including the new terminal apparatus approved to participate. In selecting any one of the plurality of terminal apparatuses, a terminal apparatus to be selected is switched among the plurality of terminal apparatuses.

Another embodiment of the present invention relates to a communication system. The communication system comprises: a plurality of terminal apparatuses operative to communicate by forming an ad hoc network; and a new terminal apparatus operative to request participating in the ad hoc network formed by the plurality of terminal apparatuses. Any one of the plurality of terminal apparatuses is selected to have a role of approving participation of a new terminal apparatus in the ad hoc network, and a terminal apparatus to be selected is switched among the plurality of terminal apparatuses.

Optional combinations of the aforementioned constituting elements, and implementations of the invention in the form of methods, apparatuses, systems, recording mediums, and computer programs may also be practiced as additional modes of the present invention.

### Effect of the Invention

According to the present invention, an approval process can be performed even when the configuration of an ad hoc network changes.

### BRIEF DESCRIPTION OF DRAWINGS

FIG. 1 is a diagram illustrating the configuration of a communication system according to an embodiment of the present invention;

FIG. 2 is a diagram illustrating the configuration of a terminal apparatus shown in FIG. 1;

FIG. 3 is a diagram illustrating the data structure of a routing table stored in a memory unit shown in FIG. 2;

FIG. 4 is a sequence diagram illustrating a connecting procedure in a communication system shown in FIG. 1;

FIG. 5 is a sequence diagram illustrating a modification procedure of a registrar in the communication system shown in FIG. 1;

FIG. 6 is a flowchart illustrating a modification procedure of a registrar in the terminal apparatus shown in FIG. 2;

FIG. 7 is a sequence diagram illustrating another modification procedure of a registrar in the communication system shown in FIG. 1;

FIG. 8 is a flowchart illustrating another modification procedure of a registrar in the terminal apparatus shown in FIG. 2;

FIG. 9 is a sequence diagram illustrating yet another modification procedure of a registrar in the communication system shown in FIG. 1;

FIG. 10 is a flowchart illustrating yet another modification procedure of a registrar in the terminal apparatus shown in FIG. 2;

FIG. 11 is a flowchart illustrating yet another modification procedure of a registrar in the terminal apparatus shown in FIG. 2;

FIG. 12 is a sequence diagram illustrating yet another modification procedure of a registrar in the communication system shown in FIG. 1;

FIG. 13 is a flowchart illustrating an updating procedure of average received power in the terminal apparatus shown in FIG. 2;

FIG. 14 is a sequence diagram illustrating yet another modification procedure of a registrar in the communication system shown in FIG. 1;

FIG. 15 is a flowchart illustrating a connecting procedure in the terminal apparatus shown in FIG. 2;

FIG. 16 is a diagram illustrating the configuration of a terminal apparatus according to the exemplary variation of the present invention;

FIG. 17 is a sequence diagram illustrating a modification procedure of a registrar in the communication system according to the exemplary variation of the present invention;

FIG. 18 is a diagram illustrating the configuration of a control unit according to yet another exemplary variation of the present invention;

FIG. 19 is a diagram illustrating the configuration of a vehicle camera apparatus according to yet another exemplary variation of the present invention;

FIG. 20 is a diagram illustrating the configuration of the control unit in FIG. 19;

FIG. 21 is a sequence diagram illustrating a setting procedure in the communication system according to yet another exemplary variation of the present invention;

FIG. 22 is a flowchart illustrating a setting procedure in a terminal apparatus according to yet another exemplary variation of the present invention;

FIG. 23 is a flowchart illustrating a setting procedure in the vehicle camera apparatus shown in FIG. 19; and

FIG. 24 is a sequence diagram illustrating a modification procedure of a registrar in the communication system according to yet another exemplary variation of the present invention.

### EXPLANATION OF REFERENCES

| | |
|---|---|
| 10 | terminal apparatus |
| 12 | wireless unit |
| 14 | modem unit |
| 16 | processing unit |
| 18 | control unit |
| 20 | memory unit |
| 22 | operation unit |
| 24 | monitor |
| 26 | speaker |
| 100 | communication system |

### BEST MODE FOR CARRYING OUT THE INVENTION

An outline of the present invention will be given before a specific description thereof. Exemplary embodiments of the present invention relate to a communication system that executes an ad hoc network formed by multiple terminal apparatuses. In an ad hoc network, any one of the multiple terminal apparatuses is determined to be the above-stated registrar. As previously described, there is a possibility that a terminal apparatus serving as a registrar leaves the ad hoc network. Even when the terminal apparatus serving as a registrar leaves the ad hoc network, the communication system according to the exemplary embodiment of the present invention performs the following process on a terminal apparatus wishing to participate in the ad hoc network.

The terminal apparatus serving as a registrar gives notification to the ad hoc network indicating that the terminal apparatus is leaving when leaving the ad hoc network. Upon detection that the terminal apparatus is leaving, other terminal apparatuses forming the ad hoc network exchange information with one another regarding the period of time since each terminal apparatus has joined the ad hoc network. As a result, the terminal apparatus with the longest period since the terminal apparatus has joined the ad hoc network is selected as a next registrar. The subsequently selected registrar performs an approval process on a terminal apparatus wishing to participate in the ad hoc network so that the new terminal apparatus can participate in the ad hoc network.

A communication system mainly performs: (1) a process of connecting a new terminal apparatus to an ad hoc network (hereinafter, referred to as “connection process”); (2) a process of generating a routing table for the ad hoc network (hereinafter, referred to as “generation process”); and (3) a process of transferring a data signal in the ad hoc network based on the routing table (hereinafter, referred to as “transfer process”). The previously-stated approval process is included in the connection process of the item (1).

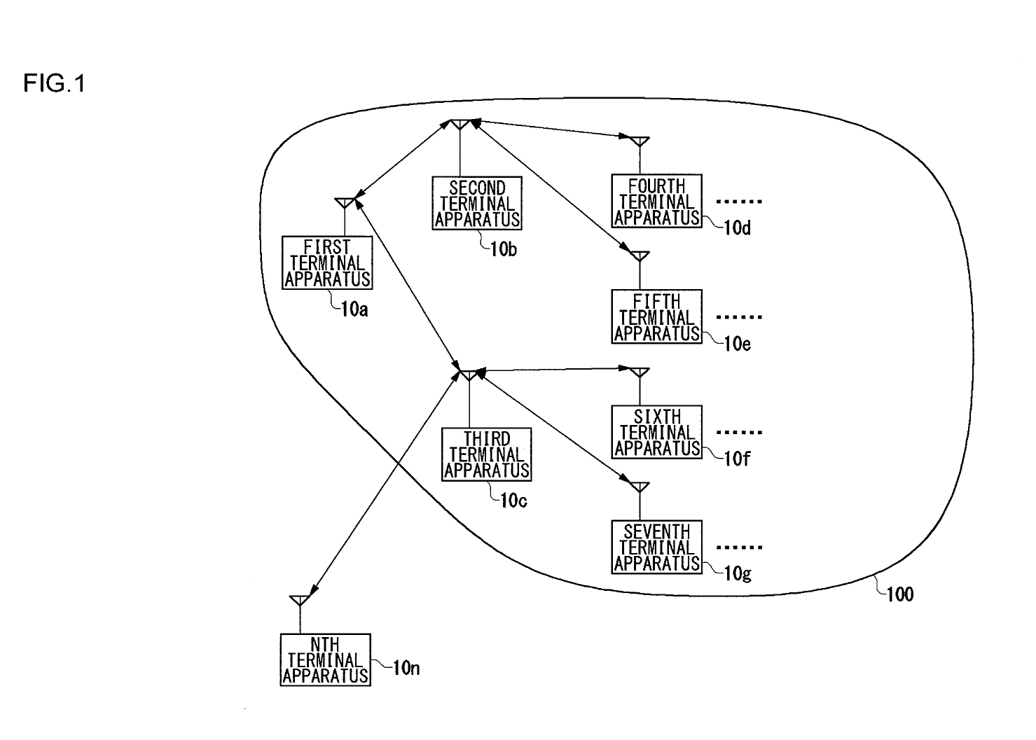

FIG. 1 shows the configuration of a communication system 100 according to the embodiment of the present invention. The communication system 100 includes a first terminal apparatus 10a, a second terminal apparatus 10b, a third terminal apparatus 10c, a fourth terminal apparatus 10d, a fifth terminal apparatus 10e, a sixth terminal apparatus 10f, and a seventh terminal apparatus 10g, which are all generically called a terminal apparatus 10. An Nth terminal apparatus 10n is about to be included in the communication system 100.

Multiple terminal apparatuses 10, for example, the first terminal apparatus 10a through the seventh terminal apparatus 10g, communicate by forming an ad hoc network. The terminal apparatus 10 constituting the ad hoc network is not limited to the first terminal apparatus 10a through the seventh terminal apparatus 10g. The multiple terminal apparatuses 10, for example, correspond to a wireless LAN system that complies with standards such as IEEE 802.11. As previously described, routing methods for ad hoc networks need to correspond to publicly-known techniques such as a table driving method, an on-demand method, and a hybrid method. For example, in the case of corresponding to a table driving method, a routing table is updated by a publicly-known technique.

In addition to a communication function in a normal ad hoc network, a role of approving the participation of a new terminal apparatus 10 in the ad hoc network is assigned to any one of multiple terminal apparatuses 10, for example, the third terminal apparatus 10c. In other words, the third terminal apparatus 10c corresponds to the previously-stated registrar. A registrar can be described as a component having an authorization to issue or cancel a qualification to participate in an ad hoc network. The processes performed in the registrar will hereinafter be described in detail. The function of the registrar is provided to the terminal apparatuses 10 other than the third terminal apparatus 10c; however, the function is assumed to be inactive under the present circumstances. In order to clarify the explanation, it is assumed that one registrar is included in the communication system 100.

The new terminal apparatus 10, in other words, the Nth terminal apparatus 10n requests participation in the ad hoc network formed by the multiple terminal apparatuses 10. The Nth terminal apparatus 10n makes a request to the registrar for participation. When participation is allowed by the registrar, the Nth terminal apparatus 10n becomes a component of the communication system 100. In the following explanation, the Nth terminal apparatus 10n and the registrar may be referred to as a “requestor” and a “responder,” respectively, for convenience sake.

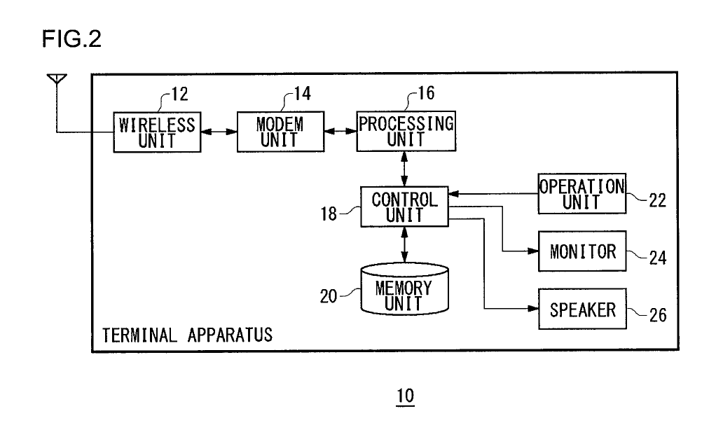

FIG. 2 shows the configuration of the terminal apparatus 10. The terminal apparatus 10 includes a wireless unit 12, a modem unit 14, a processing unit 16, a memory unit 20, an operation unit 22, a monitor 24, and a speaker 26. FIG. 1 shows the multiple terminal apparatuses 10 and further shows terminal apparatuses 10 that correspond to a requestor and to a responder. All the terminal apparatuses 10 have configurations as shown in FIG. 2.

The wireless unit 12 performs communication while forming an ad hoc network with other terminal apparatuses 10. The wireless unit 12 performs frequency conversion on a wireless frequency signal received via an antenna and generates a baseband signal, acting as a reception process. Furthermore, the wireless unit 12 outputs the baseband signal to the modem unit 14. In general, a baseband signal is formed by both an in-phase component and a quadrature component, and two signal lines should thus be shown. However, for the purpose of clarifying the figure, only one signal line is shown. The wireless unit 12 also includes an LNA (Low Noise Amplifier), a mixer, an AGC, and an A/D converter.

The wireless unit 12 performs frequency conversion on a baseband signal input from the modem unit 14 and generates a wireless frequency signal, acting as a transmission process. Furthermore, the wireless unit 12 transmits the wireless frequency signal from an antenna. The wireless unit 12 also includes a PA (Power Amplifier), a mixer, and a D/A converter.

The modem unit 14 performs demodulation on the baseband signal from the wireless unit 12, acting as a reception process. Furthermore, the modem unit 14 outputs a result of demodulation to the processing unit 16. The modem unit 14 performs modulation on a signal from the processing unit 16, acting as a transmission process. Furthermore, the modem unit 14 outputs the result of modulation to the wireless unit 12 as a baseband signal. When the terminal apparatus 10 corresponds to an OFDM modulation scheme such as an IEEE802.11a standard, the modem unit 14 performs FFT as a reception process and performs IFFT as a transmission process.

When the terminal apparatus 10 corresponds to a spread spectrum scheme such as the IEEE802.11b standard, the modem unit 14 performs despreading, which acts as a reception process, and performs spreading, which acts as a transmission process. Moreover, when the terminal apparatus 10 corresponds to an MIMO scheme such as an IEEE802.11n, the modem unit 14 performs adaptive array signal processing, which acts as a reception process and performs distributed processing on multiple streams, which acts as a transmission process.

The processing unit 16 performs digital signal processing on the signal from the modem unit 14 and on the signal to the modem unit 14. An example of the digital signal processing is error correction coding, acting as a transmission process or error correction decoding, acting as a reception process. The digital signal processing is not limited to these processes. The processing unit 16 outputs to the control unit 18 the result of performing digital signal processing on the signal from the modem unit 14 and inputs from the control unit 18 a signal used as a basis for the signal to the modem unit 14.

The control unit 18 controls the overall movement of the terminal apparatus 10. The processes performed by the control unit 18 are mainly classified into: (1) a connection process; (2) a generation process; (3) a transfer process, which are all previously stated, and (4) an input and output data process. For the sake of ease of explanation, the explanation is given in the order of items (4), (2), and (3) and then the item (1) at the end. First, the explanation is given of the item (4), the input and output data process. The control unit 18 receives the result of digital signal processing from the processing unit 16, acting as an output process, and outputs the result to a monitor 24 and a speaker 26. The control unit 18 receives an instruction signal from the operation unit 22, acting as an input process and outputs corresponding data to the processing unit 16. The operation unit 22 is constituted with a button and the like. When the terminal apparatus 10 is formed so as to be connected with a personal computer, the operation unit 22 may be a keyboard or a mouse, which is provided with the personal computer.

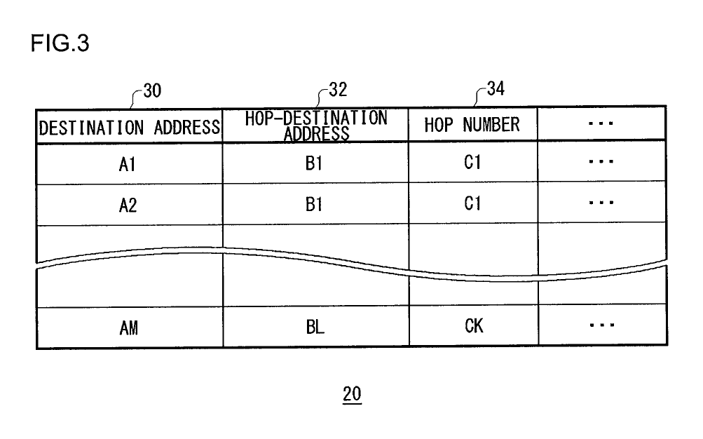

The explanation is now given of the item (2), the generation process. As previously described, publicly-known techniques need to be used for the generation of a routing table. The control unit 18 stores a generated routing table in the memory unit 20. FIG. 3 shows the data structure of a routing table stored in the memory unit 20. As shown in the figure, the routing table includes a destination address column 30, a hop-destination address column 32, and a hop number column 34. The routing table may include other information. In the figure, the addresses are shown as “A1,” “B1,” etc., in the destination address column 30 and in the hop-destination address column 32. In reality, the addresses are shown by, for example, IP addresses. The same applies to the hop number in the hop number column 34. FIG. 2 is referred back again.

The explanation is now given of the item (3), the transfer process. As previously described, publicly-known techniques need to be used for the transfer process. The control unit 18 acquires the destination address of a packet signal received via the wireless unit 12 through the processing unit 16. The control unit 18 identifies the hop-destination address that corresponds to an acquired destination address by referring to the routing table stored in the memory unit 20. Moreover, the control unit 18 transmits a packet signal to the identified hop-destination address via the processing unit 16 through the wireless unit 12.

The explanation is now given of the item (1), the connection process. The connection process is performed by the terminal apparatus 10 of the requestor and the terminal apparatus 10 of the responder. The explanation is given of the process of the control unit 18 in the terminal apparatus 10 of the requestor, followed by the explanation of the process of the control unit 18 in the terminal apparatus 10 of the responder. The terminal apparatus 10 of the requestor corresponds to the Nth terminal apparatus 10n of FIG. 1, and the terminal apparatus 10 of the responder corresponds to the third terminal apparatus 10c of FIG. 1.

The control unit 18 in the terminal apparatus 10 of the requestor enters into a request mode upon detection of the button of the operation unit 22 being pushed down by a user. Once entering the request mode, the control unit 18 controls the processing unit 16 through the wireless unit 12 so as to transmit to a registrar a packet signal indicating a request for participating in an ad hoc network (hereinafter, referred to as “request signal”). The wireless unit 12 through the processing unit 16 receive from the registrar to which the request signal has been transmitted a packet signal indicating the approval for the participation (hereinafter, referred to as “enabling signal”). An enabling signal is input to the control unit 18. As a result, the control unit 18 enters into a communication mode. Once entering into the communication mode, the control unit 18 controls the wireless unit 12 through the processing unit 16 so that a communication is performed by participating in an ad hoc network.

The control unit 18 in the terminal apparatus 10 of the responder enters an approval mode upon detecting that the predetermined button of the operation unit 22 is pushed down by a user. The approval mode is a state where an approval process can be performed. Once entering into the approval mode, the control unit 18 receives a request signal from the terminal apparatus 10 of the requestor over a predetermined period via the wireless unit 12 through the processing unit 16. The control unit 18 performs the approval process on the received request signal. Publicly-known techniques need to be used for the approval process. For example, the control unit 18 performs a recognition process and an identification process on the terminal apparatus of the requestor after exchanging a public key with the terminal apparatus 10 of the requestor via the wireless unit 12 through the processing unit 16. A “device password” needs to be used for the recognition process.

When the participation is approved, the control unit 18 transmits an enabling signal to the terminal apparatus 10 of the requestor via the processing unit 16 through the wireless unit 12. On the other hand, when the participation is rejected, the control unit 18 transmits a rejection signal to the terminal apparatus 10 of the requestor via the processing unit 16 through the wireless unit 12. After a certain period, the control unit 18 enters a communication mode. Once entering into the communication mode, the control unit 18 controls the wireless unit 12 through the processing unit 16 so that a communication is performed by participating in an ad hoc network.

The configuration is implemented in hardware by any CPU of a computer, memory, or other LSI's and in software by a program having a communication function or the like loaded into the memory. Functional blocks are implemented by the cooperation of hardware and software. Thus, a person skilled in the art should appreciate that there are many ways of accomplishing these functional blocks in various forms in accordance with the components of hardware only, software only, or the combination of both.

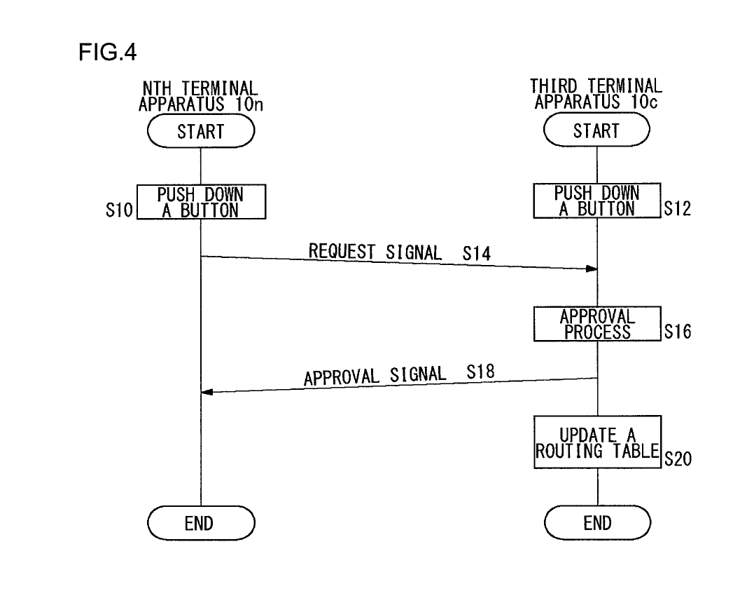

The explanation is given of the movement of the communication system 100 having the above-stated configuration. FIG. 4 is a sequence diagram showing a connecting procedure in the communication system 100. The button of the Nth terminal apparatus 10n is pushed down (S10), and the button of the third terminal apparatus 10c is pushed down (S12). The Nth terminal apparatus 10n transmits a request signal to the third terminal apparatus 10c (S14). The third terminal apparatus 10c performs the approval process on the Nth terminal apparatus 10n (S16). The third terminal apparatus 10c transmits an enabling signal to the Nth terminal apparatus 10n (S18). The third terminal apparatus 10c updates a routing table (S20).

The detailed explanation is given in the following of the item (1), the connection process, and particularly of the process performed in the previous step of the previously-stated connection process. As previously stated, the connection process is started by pushing down the button of the terminal apparatus 10 of the responder and by pushing down the button of the terminal apparatus 10 of the requestor. In an ad hoc network, a registrar is configured with a general terminal apparatus and is used for communication. Therefore, the terminal apparatus 10 that is assigned to be the registrar may leave the communication system 100. When no registrar exists in the communication system 100, the terminal apparatus 10 of the requestor cannot join the communication system 100. The terminal apparatuses 10 in the communication system 100 are configured as shown in the following so that the terminal apparatus 10 of the requestor can participate in the communication system 100 even in this kind of situation.

Any one of the multiple terminal apparatuses 10 included in the communication system 100 is selected to be the registrar, and the terminal apparatus 10 to be selected is switched among the multiple terminal apparatuses 10. In other words, even when the terminal apparatus 10 that is assigned to be the registrar leaves the communication system 100, another terminal apparatus 10 is assigned to be the registrar. In order not to lower the user-friendliness, it is desirable that a new registrar is automatically determined. Thus, a rule for automatically determining a new registrar is necessary. In the following, a detailed description will be made regarding the rule and a processing procedure that follows the rule.

Among the multiple terminal apparatuses 10 included in the communication system 100, the terminal apparatus 10 that has participated in the communication system 100 for a long time is selected to be the registrar. Upon detecting, via the wireless unit 12 through the processing unit 16, the departure of the terminal apparatus 10 assigned to be the registrar, the control unit 18 calculates the period of participation in the communication system 100. The departure of the terminal apparatus 10 assigned to be the registrar is detected by publicly-known techniques, and the explanation thereof is thus omitted. The control unit 18 gives, via the processing unit 16 through the wireless unit 12, notification of a signal including the calculated period (hereinafter, referred to as “period information”). Upon the receipt of the period information via the wireless unit 12 through the processing unit 16, the control unit 18 of another terminal apparatus 10 gives notification of its own period information via the processing unit 16 through the wireless unit 12 after generating its own period information.

By the above-stated processes, the multiple terminal apparatuses 10 in the communication system 100 exchange their period information with one another. The control unit 18 of each terminal apparatus 10 specifies as the registrar the terminal apparatus 10 has participated in the communication system 100 for the longest time by comparing multiple period information sets. In order for the multiple terminal apparatuses 10 to commonly recognize the registrar, the terminal apparatus 10 identifying itself as the registrar may gives notification indicating accordingly.

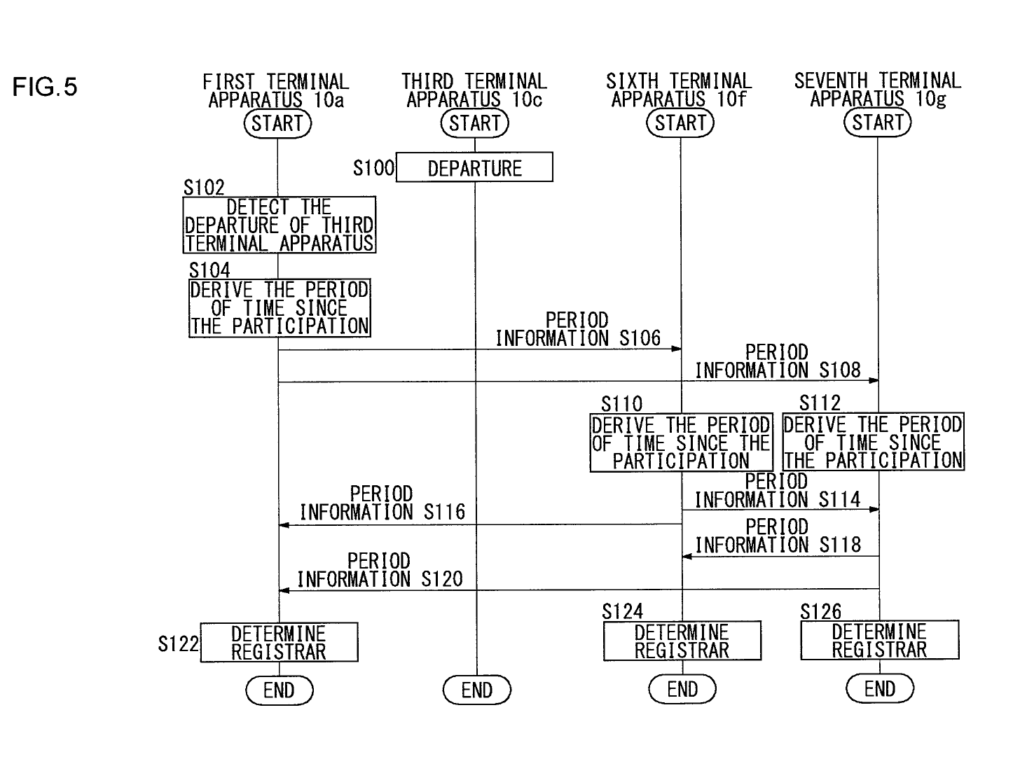

FIG. 5 is a sequence diagram showing a modification procedure of a registrar in the communication system 100. As previously described, the third terminal apparatus 10c is assumed to be the registrar. The third terminal apparatus 10c leaves the communication system 100 (S100). Upon detecting the departure of the third terminal apparatus 10c (S102), the first terminal apparatus 10a derives the period of participation in the communication system 100 (S104). The first terminal apparatus 10a gives notification of the information of the derived period (S106 and S108). In FIG. 5, the notification of the period information is shown in another step for convenience sake. Upon the receipt of the period information, the sixth terminal apparatus 10f derives the period of participation in the communication system 100 (S110). Upon the receipt of the period information, the seventh terminal apparatus 10g also derives the period of participation in the communication system 100 (S112). The sixth terminal apparatus 10f gives notification of the information of the derived period (S114 and S116), and the seventh terminal apparatus 10g also gives notification of the information of the derived period (S118 and S120). The first terminal apparatus 10a, the sixth terminal apparatus 10f, and the seventh terminal apparatus 10g all determine the registrar based on the period information (S122, S124 and S126).

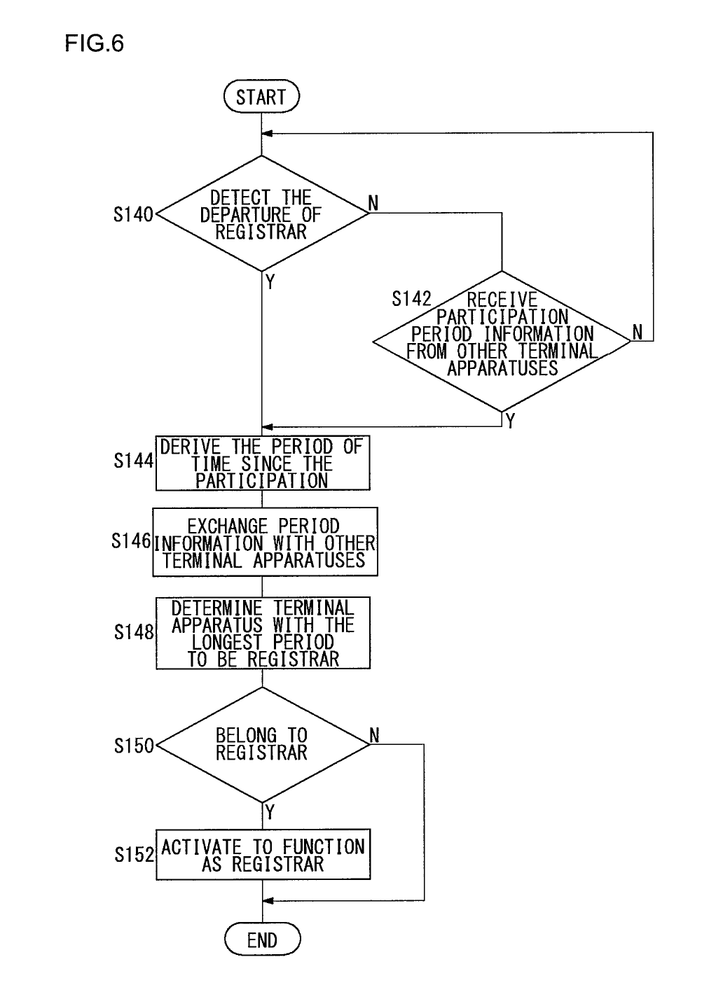

FIG. 6 is a flowchart illustrating a modification procedure of the registrar in the terminal apparatus 10. The control unit 18 is on stand-by when it does not detect, via the wireless unit 12 through the processing unit 16, the departure of the registrar (N in S140) and when it does not receive any period information from other terminal apparatuses 10 (N in S142). On the other hand, the control unit 18 derives the period of participation in the communication system 100 (S144) when it detects, via the wireless unit 12 through the processing unit 16, the departure of the registrar (Y in S140) or when it receives the period information from other terminal apparatuses 10 (Y in S142). After exchanging the period information with other terminal apparatuses 10 (S146), the control unit 18 determines the terminal apparatus 10 with the longest period to be the registrar (S148). The control unit 18 that belongs to the terminal apparatus 10 that serves as the registrar (Y in S150) activates itself to function as a registrar (S152). On the other hand, when the control unit 18 does not belong to the terminal apparatus 10 that serves as the registrar (N in S150), the process is terminated.

A description is given of another rule. Each terminal apparatus 10 transmits a notification signal on a regular basis. In addition to receiving the notification signals from other terminal apparatuses 10, each terminal apparatus 10 calculates the number of other terminal apparatuses 10 whose notification signals the terminal apparatus 10 can receive. Moreover, the terminal apparatus 10 with a large calculated number is selected as the registrar. It can be considered that the terminal apparatus 10 that can receive the notification signals from many other terminal apparatuses 10 is close to many other terminal apparatuses 10. Such a terminal apparatus 10 can be considered to be located in the center part of the existence density of the terminal apparatuses 10 in the communication system 100.

Giving a further detailed description on the process, a notification signal includes information for identifying the terminal apparatus 10 that has sent the notification signal (hereinafter, referred to as “identification information”) and can be said to be a signal for showing the existence. Upon the receipt of the notification signal via the wireless unit 12 through the processing unit 16, the control unit 18 checks the identification information. The control unit 18 adds up the number of terminal apparatuses 10 when the terminal apparatus 10 is recognized to be new from the identification information. An expiration date is provided to the reception result of the notification signal, and the control unit 18 reduces the number of the terminal apparatuses 10 after the expiration date.

Upon the detection, via the wireless unit 12 through the processing unit 16, of the departure of the terminal apparatus 10 assigned to be the registrar, the control unit 18 gives notification of a signal indicating the number of terminal apparatuses 10 (hereinafter, referred to as “terminal apparatus number information”) via the processing unit 16 through the wireless unit 12. Upon the receipt of the terminal apparatus number information via the wireless unit 12 through the processing unit 16, the control unit 18 in another terminal apparatus 10 gives notification of its own terminal apparatus number information via the processing unit 16 through the wireless unit 12. By the above-stated processes, the multiple terminal apparatuses 10 in the communication system 100 exchange their terminal apparatus number information with one another. The control unit 18 of each terminal apparatus 10 specifies, as the registrar, the terminal apparatus 10 with a large calculated number by comparing multiple terminal apparatus number information sets. In order for the multiple terminal apparatuses 10 to commonly recognize the registrar, the terminal apparatus 10 identifying itself as the registrar may gives notification indicating that the terminal apparatus 10 is the registrar.

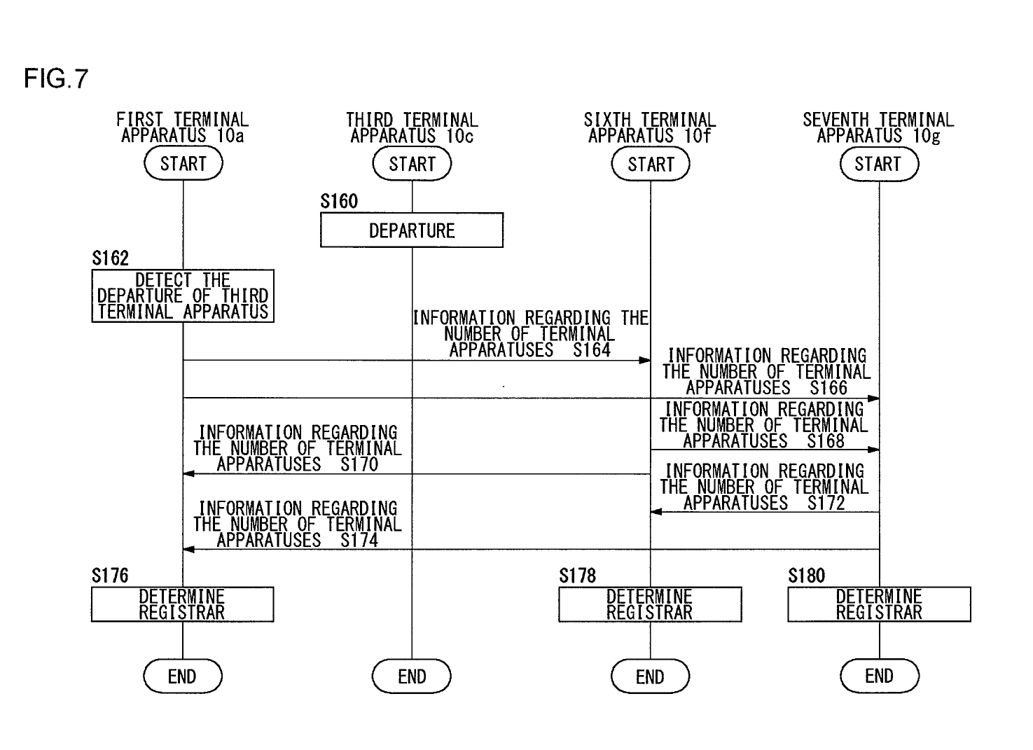

FIG. 7 is a sequence diagram showing another modification procedure of the registrar in the communication system 100. As previously described, the third terminal apparatus 10c is assumed to be the registrar. The third terminal apparatus 10c leaves the communication system 100 (S160). Upon the detection of the departure of the third terminal apparatus 10c (S162), the first terminal apparatus 10a gives notification of the terminal apparatus number information (S164 and S166). Upon the receipt of the terminal apparatus number information, the sixth terminal apparatus 10f gives notification of its terminal apparatus number information (S168 and S170); upon the receipt of the terminal apparatus number information, the seventh terminal apparatus 10g also gives notification of its terminal apparatus number information (S172 and S174). The first terminal apparatus 10a, the sixth terminal apparatus 10f, and the seventh terminal apparatus 10g all determine the registrar based on the terminal apparatus number information (S176, S178, and S180).

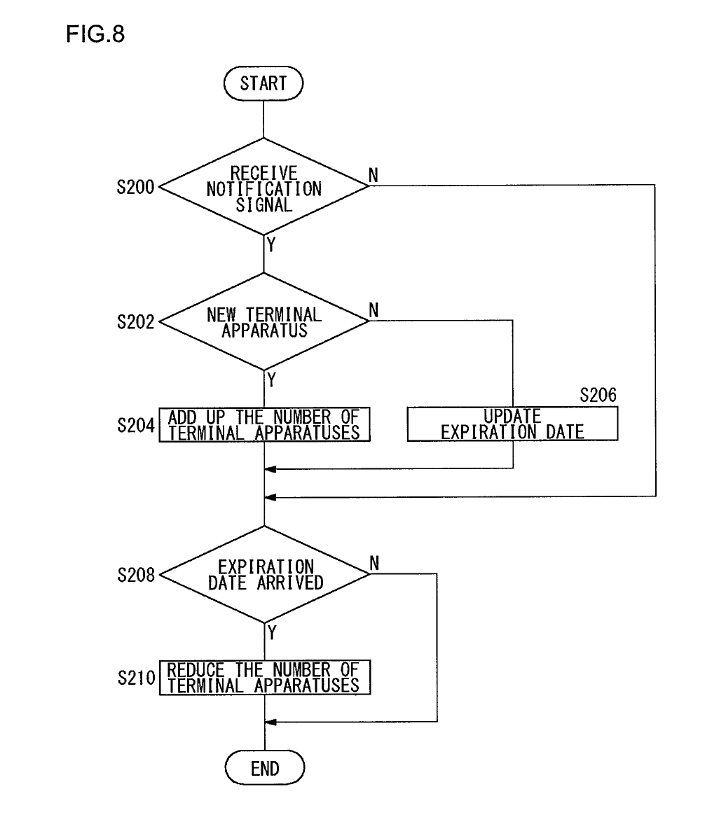

FIG. 8 is a flowchart illustrating another modification procedure of the registrar in the terminal apparatus 10. A detailed description will be made particularly regarding a generation procedure of the terminal apparatus number information. The control unit 18 receives a notification signal via the wireless unit 12 through the processing unit 16 (Y in S200) and adds up the number of terminal apparatuses (S204) when the source of the notification signal is a new terminal apparatus 10 (Y in S202). On the other hand, when the source of the notification signal is not a new terminal apparatus 10 (N in S202), the control unit 18 updates the expiration date (S206). When the control unit 18 does not receive the notification signal via the wireless unit 12 through the processing unit 16 (N in S200), the processes from Step 202 through Step 206 are skipped. When the expiration date arrives (Y in S208), the control unit 18 reduces the number of terminal apparatuses (S210). On the other hand, when the expiration date has not arrived (N in S208), the process is terminated. The same as described for FIG. 6 applies to the subsequent processes. Thus, the explanation thereof is omitted.

A description is given of another rule. Among the multiple terminal apparatuses 10 included in the communication system 100, the terminal apparatus 10 that has a high processing speed is selected to be the registrar. Upon the detection, via the wireless unit 12 through the processing unit 16, of the departure of the terminal apparatus 10 assigned to be the registrar, the control unit 18 gives notification of processing speed information via the processing unit 16 through the wireless unit 12. The processing speed information specifies the processing speed of a CPU (not shown) mounted on the terminal apparatus 10. The value of the processing speed of the CPU in consideration of the effect of traffic may be derived as the processing speed information. For example, the processing speed is corrected to be low in the case of heavy traffic. Upon the receipt of the processing speed information via the wireless unit 12 through the processing unit 16, the control unit 18 in another terminal apparatus 10 gives notification of its own processing speed information via the processing unit 16 through the wireless unit 12 after generating its own processing speed information.

By the above-stated processes, the multiple terminal apparatuses 10 in the communication system 100 exchange their processing speed information with one another. The control unit 18 of each terminal apparatus 10 specifies, as the registrar, the terminal apparatus 10 having the highest processing speed by comparing multiple processing speed information sets. In order for the multiple terminal apparatuses 10 to commonly recognize the registrar, the terminal apparatus 10 identifying itself as the registrar may gives notification indicating accordingly.

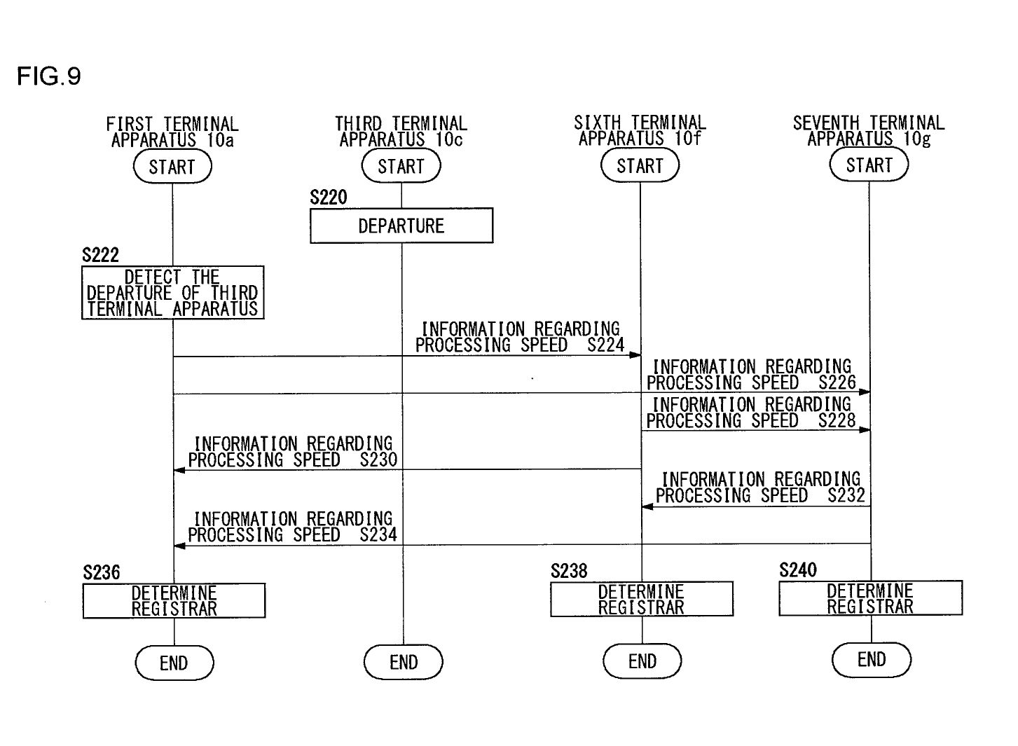

FIG. 9 is a sequence diagram showing yet another modification procedure of the registrar in the communication system 100. As previously described, the third terminal apparatus 10c is assumed to be the registrar. The third terminal apparatus 10c leaves the communication system 100 (S220). Upon the detection of the departure of the third terminal apparatus 10c (S222), the first terminal apparatus 10a gives notification of the processing speed information (S224 and S226). Upon the receipt of the processing speed information, the sixth terminal apparatus 10f gives notification of its processing speed information (S228 and S230); upon the receipt of the processing speed information, the seventh terminal apparatus 10g also gives notification of its processing speed information (S232 and S234). The first terminal apparatus 10a, the sixth terminal apparatus 10f, and the seventh terminal apparatus 10g all determine the registrar based on the processing speed information (S236, S238, and S240).

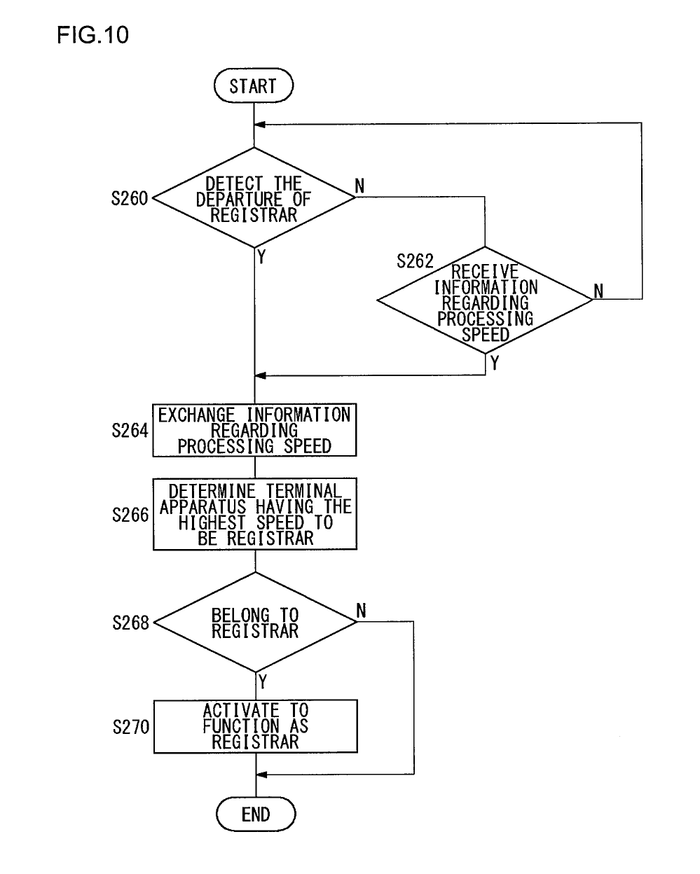

FIG. 10 is a flowchart illustrating yet another Modification procedure of the registrar in the terminal apparatus 10. The control unit 18 is on stand-by when it does not detect, via the wireless unit 12 through the processing unit 16, the departure of the registrar (N in S260) and when it does not receive any processing speed information from other terminal apparatuses 10 (N in S262). On the other hand, the control unit 18 determines the terminal apparatus 10 with the highest processing speed (S266) after exchanging the processing speed information with other terminal apparatuses 10 (S264) when detecting, via the wireless unit 12 through the processing unit 16, the departure of the registrar (Y in S260) or when receiving the processing speed information from other terminal apparatuses 10 (Y in S262). The control unit 18 that belongs to the terminal apparatus 10 that serves as the registrar (Y in S268) activates the function of the registrar (S270). On the other hand, when the control unit 18 does not belong to the terminal apparatus 10 that serves as the registrar (N in S268), the process is terminated.

A description is given of yet another rule. Among the multiple terminal apparatuses 10 included in the communication system 100, a terminal apparatus 10 that has detected the departure of the terminal apparatus 10, which has been assigned to be the registrar, from the communication system 100 is selected to be a registrar. Upon the detection, via the wireless unit 12 through the processing unit 16, of the departure of the terminal apparatus 10 assigned to be the registrar, the control unit 18 activates itself to function as a registrar. The control unit 18 gives notification via the processing unit 16 through the wireless unit 12 indicating that the control unit 18 belongs to the registrar. Moreover, upon the receipt of the information indicating the information source to be the registrar via the wireless unit 12 through the processing unit 16, the control unit 18 of another terminal apparatus 10 identifies the terminal apparatus 10 that has given notification of the information as a new registrar.

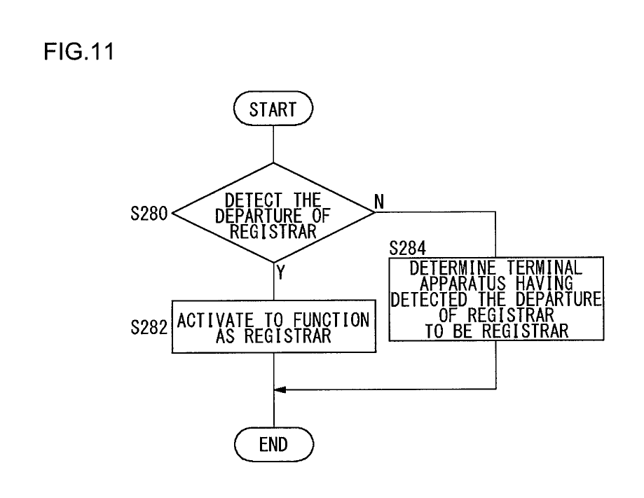

FIG. 11 is a flowchart illustrating yet another modification procedure of the registrar in the terminal apparatus 10. Upon the detection of the departure of the registrar via the wireless unit 12 through the processing unit 16 (Y in S280), the control unit 18 actives itself to function as a registrar (S282). On the other hand, the control unit 18, when it does not detect the departure of the registrar via the wireless unit 12 through the processing unit 16 (N in S280), determines another terminal apparatus 10 that has detected the departure of the registrar (S284). The process is terminated after this.

A description is given of yet another rule. Each terminal apparatus 10 transmits a notification signal on regular basis. As previously stated, such a notification signal can be said to be a signal for showing the existence of the terminal apparatus 10. In addition to receiving the notification signals from other terminal apparatuses 10, each terminal apparatus 10 measures the quality of the received notification signal. The quality may be, for example, received power and it may be average received power. The latter is used in the following. Moreover, based on the received power, at least one terminal apparatus 10, for example, the terminal apparatus 10 with the highest average received power is selected.

Giving a further detailed description on the process, the wireless unit 12 measures the received power of a notification signal upon the receipt of the notification signal. Publicly-known techniques need to be used for the measurement of the received power, and the explanation thereof is thus omitted. The wireless unit 12 outputs the received power to the control unit 18 via the modem unit 14 and the processing unit 16. Upon the receipt of the notification signal via the wireless unit 12 through the processing unit 16, the control unit 18 checks the identification information included in the notification signal. When the source of the notification signal is recognized to be a new terminal apparatus 10 based on the identification information, the control unit 18 derives the average received power after incorporating the corresponding received power of the notification signal.

Upon the detection, via the wireless unit 12 through the processing unit 16, of the departure of the terminal apparatus 10 assigned to be the registrar, the control unit 18 gives notification of a signal indicating the average received power (hereinafter, such a signal is also referred to as “average received power”) via the processing unit 16 through the wireless unit 12. Upon the receipt of the average received power via the wireless unit 12 through the processing unit 16, the control unit 18 in another terminal apparatus 10 gives notification of its own received power via the processing unit 16 through the wireless unit 12. By the above-stated processes, the multiple terminal apparatuses 10 in the communication system 100 exchange their average received power with one another. The control unit 18 of each terminal apparatus 10 specifies, as the registrar, the terminal apparatus 10 having high average received power by comparing multiple average received power sets. In order for the multiple terminal apparatuses 10 to commonly recognize the registrar, the terminal apparatus 10 identifying itself as the registrar may gives notification indicating that the terminal apparatus 10 is the registrar.

In the above explanation, the quality is specified to be average received power. However, the quality may be specified to be the lowest value of received power. In that case, the control unit 18 selects the lowest value of received power and gives notification of the lowest value instead of deriving the average received power. The multiple terminal apparatuses 10 in the communication system 100 exchange their lowest received power with one another. The control unit 18 of each terminal apparatus 10 specifies, as the registrar, the terminal apparatus 10 having high lowest received power by comparing multiple sets of lowest received power. Moreover, the quality may be specified to be an error rate such as a PER (Packet Error Rate).

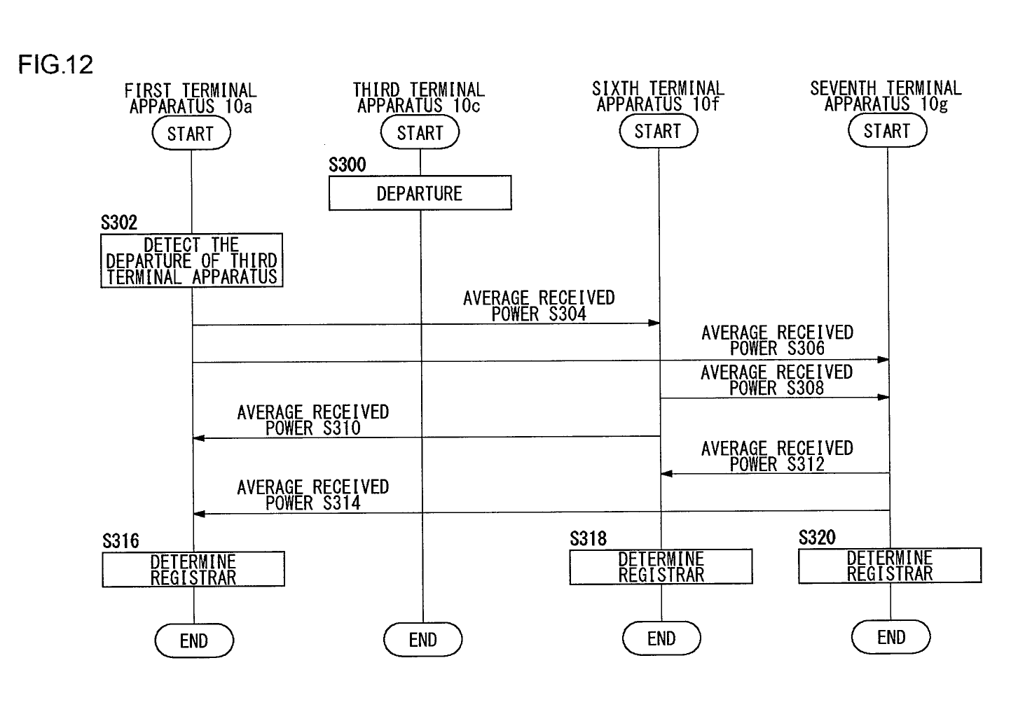

FIG. 12 is a sequence diagram showing yet another modification procedure of the registrar in the communication system 100. As previously described, the third terminal apparatus 10c is assumed to be the registrar. The third terminal apparatus 10c leaves the communication system 100 (S300). Upon the detection of the departure of the third terminal apparatus 10c (S302), the first terminal apparatus 10a gives notification of the average received power (S304 and S306). Upon the receipt of the average received power, the sixth terminal apparatus 10f gives notification of the average received power (S308 and S310); upon the receipt of the average received power, the seventh terminal apparatus 10g also gives notification of its average received power (S312 and S314). The first terminal apparatus 10a, the sixth terminal apparatus 10f, and the seventh terminal apparatus 10g all determine the registrar based on the terminal apparatus number information (S316, S318, and S320).

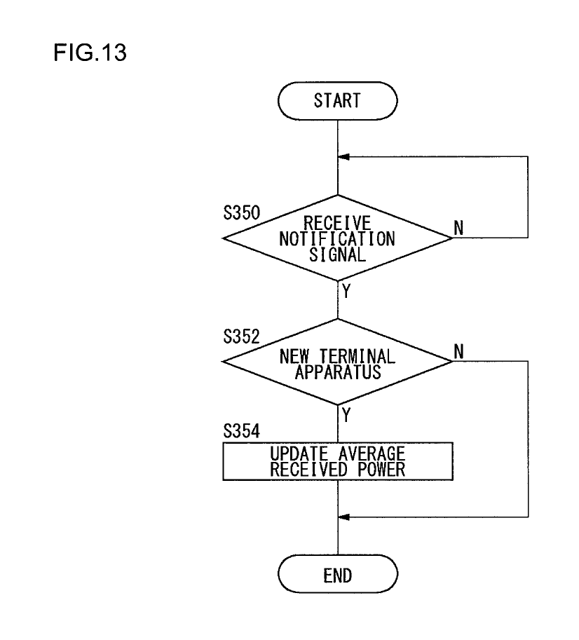

FIG. 13 is a flowchart illustrating an updating procedure of average received power in the terminal apparatus 10. The wireless unit 12 is on stand-by when it does not receive any notification signal (N in S350). The wireless unit 12 measures the received power when it receives the notification signal (Y in S350). The control unit 18 updates the average received power (S354) when the notification signal has been sent from a new terminal apparatus 10 (Y in S352). On the other hand, the control unit 18 terminates the process when the notification signal has not been sent from a new terminal apparatus 10 (N in S352).

A description is given of yet another rule. Among the multiple terminal apparatuses 10 included in the communication system 100, a terminal apparatus 10 that is specified to be a new registrar by the terminal apparatus assigned to be a registrar is selected to be a registrar. Giving a detailed description, the control unit 18 of the terminal apparatus 10 assigned to be a registrar selects one terminal apparatus from other terminal apparatuses 10 to be a new registrar. For example, the control unit 18 selects a terminal apparatus 10 with large received power of a notification signal. The control unit 18 transmits a signal including the information of the terminal apparatus 10 selected to be a new registrar (hereinafter, referred to as a “notification signal”). The control unit 18 of another terminal apparatus 10 receives the notification signal via the wireless unit 12 through the processing unit 16 and recognizes the terminal apparatus 10 specified to be a new registrar. The control unit 18 of the terminal apparatus 10 specified to be a new registrar activates itself to function as a registrar. When the terminal apparatus 10 assigned to be the original registrar receives a request signal after giving notification of a notification signal, the terminal apparatus 10 transfers the notification signal to the terminal apparatus 10 selected to be a new registrar.

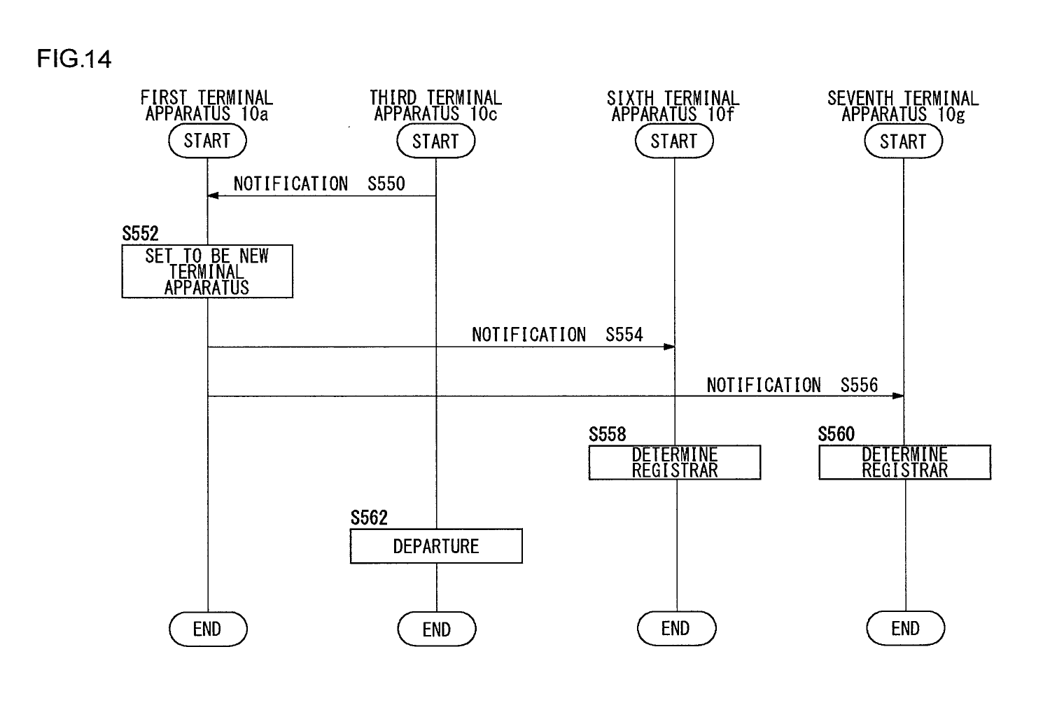

FIG. 14 is a sequence diagram showing yet another modification procedure of the registrar in the communication system 100. As previously described, the third terminal apparatus 10c is assumed to be the registrar. The third terminal apparatus 10c gives notification to the first terminal apparatus 10a indicating that the first terminal apparatus 10a is a new registrar (S550). The first terminal apparatus 10a sets itself as a new registrar (S552). The first terminal apparatus 10a gives notification indicating that it is the new registrar (S554 and S556). The sixth terminal apparatus 10f and the seventh terminal apparatus 10g determine the registrar based on the notification (S558 and S560). The third terminal apparatus 10c leaves the communication system 100 (S562).

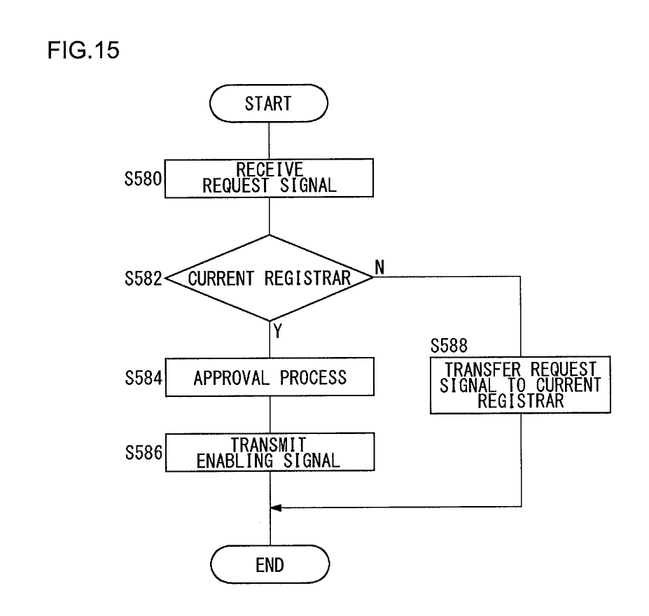

FIG. 15 is a flowchart illustrating the connecting procedure in the terminal apparatus 10. The control unit 18 receives a request signal via the wireless unit 12 through the processing unit 16 (S580). The control unit 18 performs an approval process (S584) when the control unit 18 belongs to the registrar (Y in S582) at that moment and transmits an enabling signal via the processing unit 16 through the wireless unit 12 (S586). On the other hand, the control unit 18 transfers the request signal to the current registrar via the processing unit 16 through the wireless unit 12 (S588) when the control unit does not belong to the registrar at that moment (N in S582).

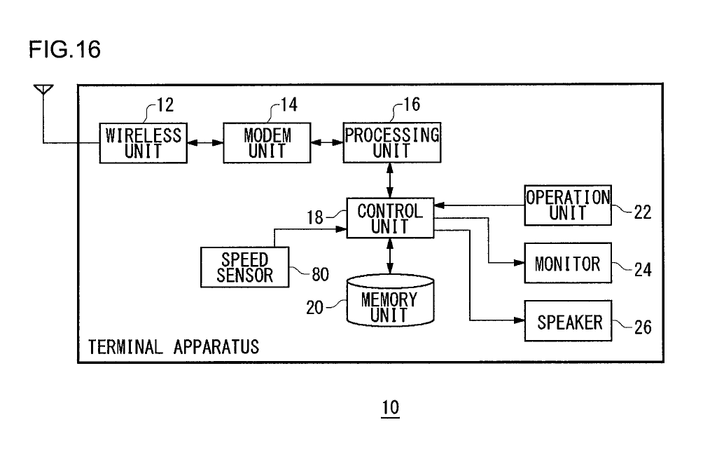

An exemplary variation of the present invention is described in detail. Among the multiple terminal apparatuses 10 included in the communication system 100, the terminal apparatus 10 that has a low moving speed is selected to be a registrar. The communication system 100 according to the exemplary variation is similar in type to that of FIG. 1. FIG. 16 illustrates the configuration of a terminal apparatus 10 according to the exemplary variation of the present invention. The terminal apparatus 10 shown in FIG. 2 with an additional speed sensor 80 represents the terminal apparatus 10 shown in FIG. 16. A detailed description will be made mainly regarding the difference from the terminal apparatus 10 shown in FIG. 2. The speed sensor 80 measures the moving speed of the terminal apparatus 10. For example, the moving speed is periodically measured. Publicly-known techniques need to be used for the measurement of the moving speed, and the explanation thereof is thus omitted. The speed sensor 80 outputs the moving speed to the control unit 18.

Upon the detection, via the wireless unit 12 through the processing unit 16, of the departure of the terminal apparatus 10 assigned to be the registrar, the control unit 18 gives notification of a signal indicating the moving speed (hereinafter, referred to as “moving speed information”) via the processing unit 16 through the wireless unit 12. Upon the receipt of the processing speed information via the wireless unit 12 through the processing unit 16, the control unit 18 in another terminal apparatus 10 gives notification of its own moving speed information via the processing unit 16 through the wireless unit 12 after generating its own moving speed information. By the above-stated processes, the multiple terminal apparatuses 10 in the communication system 100 exchange their moving speed information with one another. The control unit 18 of each terminal apparatus 10 specifies, as the registrar, the terminal apparatus 10 having the lowest moving speed by comparing multiple moving speed information sets. In order for the multiple terminal apparatuses 10 to commonly recognize the registrar, the terminal apparatus 10 identifying itself as the registrar may give notification indicating that the terminal apparatus 10 is the registrar.

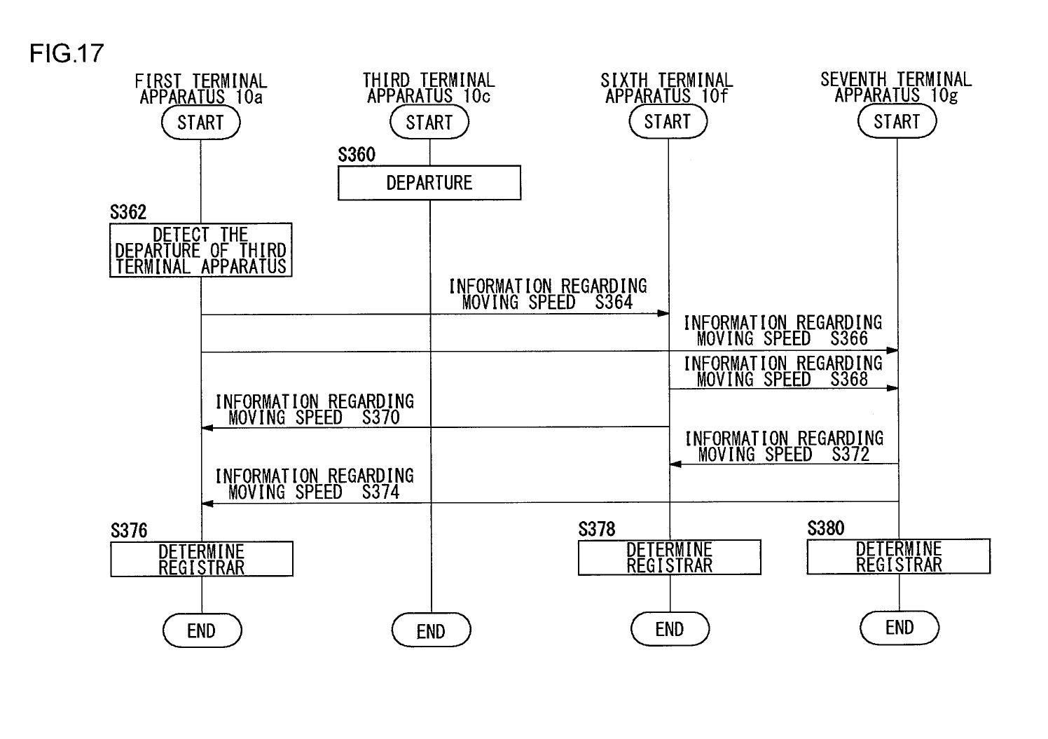

FIG. 17 is a sequence diagram illustrating a modification procedure of a registrar in the communication system 100 according to the exemplary variation of the present invention. As previously described, the third terminal apparatus 10c is assumed to be the registrar. The third terminal apparatus 10c leaves the communication system 100 (S360). Upon the detection of the departure of the third terminal apparatus 10c (S362), the first terminal apparatus 10a gives notification of the moving speed information (S364 and S366). Upon the receipt of the moving speed information, the sixth terminal apparatus 10f gives notification of its moving speed information (S368 and S370); upon the receipt of the moving speed information, the seventh terminal apparatus 10g also gives notification of its moving speed information (S372 and S374). The first terminal apparatus 10a, the sixth terminal apparatus 10f, and the seventh terminal apparatus 10g all determine the registrar based on the moving speed information (S376, S378, and S380).

Yet another exemplary variation of the present invention is described in detail. Another exemplary variation of the present invention is formed by a terminal apparatus that has the operation unit 22 (hereinafter, referred to as a “compliant apparatus”) and by a terminal apparatus that does not have the operation unit 22 (hereinafter, referred to as a “non-compliant apparatus”). By a user pressing the operation unit 22 provided to the compliant apparatus, the compliant apparatus requests a connecting process on a non-compliant apparatus. Since the non-compliant apparatus does not have the operation unit 22, the non-compliant apparatus cannot determine the time to start the connecting process and thus cannot perform the connecting process with the compliant apparatus. In order to build a secured wireless network, it is necessary to reject a request for a connecting process from a terminal apparatus not to be communicated with. Therefore, the non-compliant apparatus may perform the connecting process with the compliant apparatus as long as a predetermined condition is satisfied. The predetermined condition is, for example, such that a predetermined period of time has not been reached since the request for a connecting process has been made by the compliant apparatus and such that the compliant apparatus that has made the request is required to be connected.

In addition to a “communication mode” for a communication and an “execution mode” for performing a connecting process, the non-compliant apparatus according to another exemplary variation of the present invention defines a “preparation mode,” which is the previous step of the execution mode. The non-compliant apparatus operates so that it does not enter into the execution mode without first entering into the preparation mode. On the other hand, the compliant apparatus gives notification of a signal for requesting the transition into the preparation mode upon the receipt of the instruction from a user by a push of the operation unit 22. The non-compliant apparatus checks its own connection state upon the receipt of the request and then enters into the preparation mode when the non-compliant apparatus is not connected to any other apparatuses or when there is no apparatus to be connected with in the neighborhood. When the non-compliant apparatus enters into the preparation mode, the compliant apparatus transmits a connection request to the non-compliant apparatus, and the non-compliant apparatus then enters into the execution mode in response to the transmission. The non-compliant apparatus transitions into the execution mode when the compliant apparatus that has requested the transition into the preparation mode and the compliant apparatus that has transmitted the connection request are the same. The connection process is then performed between the two.

The communication system 100 according to another exemplary variation of the present invention is similar in type to that of FIG. 1. Some of terminal apparatuses 10 are, however, non-compliant apparatuses that have been previously described. A terminal apparatus 10 generally corresponds to a compliant apparatus. As an example of the non-compliant apparatus, a vehicle camera apparatus is taken into consideration. A vehicle camera apparatus captures the image of a moving image or a still image (hereinafter, generically referred to as an “image”) and transmits the captured image data (hereinafter, referred to as “image data”) to the terminal apparatus 10. An example of a terminal apparatus 10 is a vehicle monitor apparatus. The vehicle monitor apparatus receives image data from the vehicle camera apparatus and displays the image on the monitor. The configuration of the vehicle monitor apparatus is similar in type to that of FIG. 2.

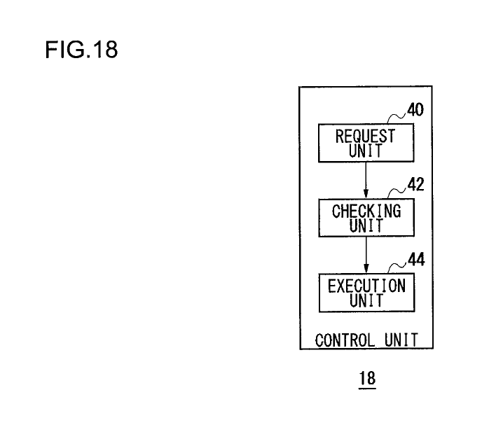

FIG. 18 illustrates the configuration of the control unit 18 according to yet another exemplary variation of the present invention. The control unit 18 includes a request unit 40, a checking unit 42, and an execution unit 44. A detailed description will be made mainly regarding the connecting process among the processes performed by the control unit 18. The request unit 40 receives an instruction from the operation unit 22 (not shown) for starting. The request unit 40 is a vehicle camera apparatus (not shown) and requests a vehicle camera apparatus, for which a setting related to a wireless network is not made, the transition into the preparation mode for preparing the setting. The signal used for requesting is referred to as a “preparation-mode-transition instruction signal.” The request unit 40 includes the information for identifying the source, that is, the terminal apparatus 10 into the preparation mode transition instruction signal. The information for identifying the terminal apparatus 10 corresponds to the identification information for identifying the terminal apparatus 10. The request unit 40 gives notification of the preparation-mode-transition instruction signal via the processing unit 16 through the wireless unit 12.

When a vehicle camera apparatus (not shown) transitions into the preparation mode in accordance with the preparation mode transition instruction signal transmitted from the request unit 40, the checking unit 42 receives a signal indicating that the vehicle camera apparatus has transmitted into the preparation mode (hereinafter, referred to as a “preparation-mode-transition completion signal”). The preparation-mode-transition completion signal reaches the checking unit 42 via the wireless unit 12 through the processing unit 16. The checking unit 42 confirms the transition of the vehicle camera apparatus into the preparation mode by receiving the preparation-mode-transition completion signal. The checking unit 42 notifies the execution unit 44 of information indicating that the confirmation has been made.

Upon the receipt from the checking unit 42 of the information indicating that the confirmation has been made, the execution unit 44 generates a signal for requesting the setting (hereinafter, referred to as a “setting request signal”). The execution unit 44 transmits the setting request signal to the vehicle camera apparatus via the processing unit 16 through the wireless unit 12. The execution unit 44 includes the information for identifying the source, that is, the terminal apparatus 10 into the preparation-mode-transition completion signal. Thus, similar information is included in the preparation-mode-transition instruction signal and the setting request signal. When the vehicle camera apparatus transitions into the execution mode for performing the setting in accordance with the setting request signal, the execution unit 44 performs the setting related to the wireless network with the vehicle camera apparatus. For example, upon the receipt of a response signal from the vehicle camera apparatus via the wireless unit 12 through the processing unit 16 after the transmission of the setting request signal, the execution unit 44 recognizes that the vehicle camera apparatus has been transitioned into the execution mode. The same applies to the setting process related to the wireless network. Thus, the explanation thereof is omitted.

The details of the setting related to the wireless network made by the execution unit 44 are stored in the memory unit 20 (not shown). When the vehicle camera apparatus transitions into the communication mode for communication after performing the setting in the execution unit 44, the control unit 18 communicates with the vehicle camera apparatus. The control unit 18 may recognize that the vehicle camera apparatus has transitioned into the communication mode when the setting process in the execution unit 44 is completed. The control unit 18 uses the details of the setting stored in the memory unit 20 in the case of communication. The preparation mode, the execution mode, and the communication mode of a vehicle camera apparatus will be described hereinafter.

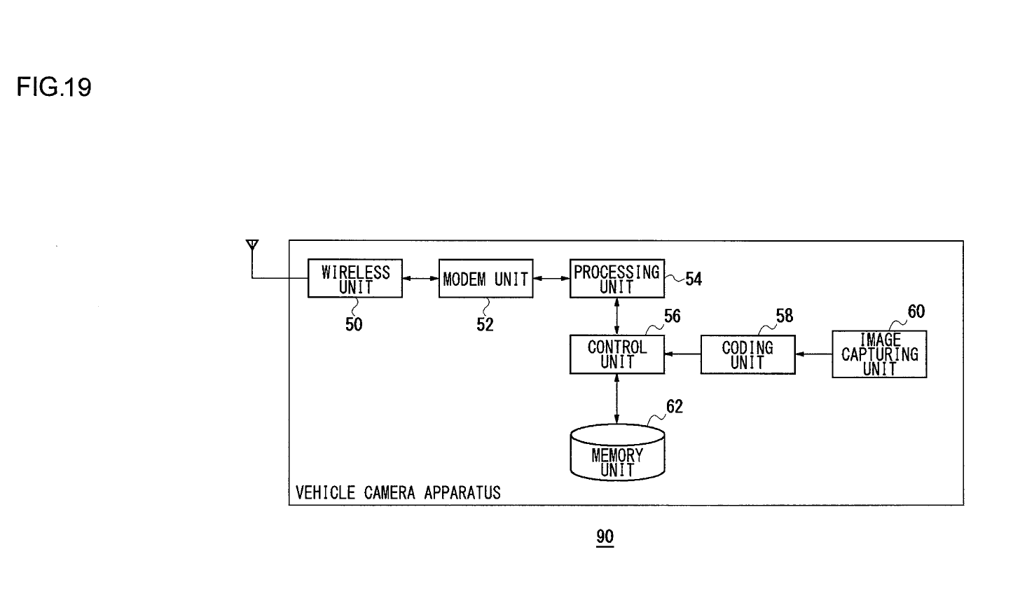

FIG. 19 illustrates the configuration of a vehicle camera apparatus 90 according to yet another exemplary variation of the present invention. The vehicle camera apparatus 90 includes a wireless unit 50, a modem unit 52, a processing unit 54, a control unit 56, a coding unit 58, an image capturing unit 60, and a memory unit 62. The wireless unit 50, the modem unit 52, and the processing unit 54 are similar in type to the wireless unit 12, the modem unit 14, and the processing unit 16, respectively. Thus, the explanation thereof is omitted.

The image capturing unit 60 corresponds to a CCD (Charge Coupled Device) image sensor and the like and acquires an image from the outside. The image capturing unit 60 outputs an acquired image to the coding unit 58. The coding unit 58 generates image data by performing a compression encoding process on the image received from the image capturing unit 60. As a compression method, for example, a Motion JPEG (Joint Photographic Experts Group) or the like is used. The coding unit 58 outputs the image data to the control unit 56.

The control unit 56 controls the overall movement of the vehicle camera apparatus 90. For example, the control unit 56 defines the communication mode, the preparation mode, and the execution mode for the operations of the vehicle camera apparatus 90 and controls both the operations of these modes and the transition among the modes. The descriptions thereof will be made hereinafter. The control unit 56 outputs the image data received from the coding unit 58 to the processing unit 54 during the communication mode. The memory unit 62 stores the identification information of the terminal apparatus 10 to be communicated. The identification information is, for example, a MAC address or an IP address.

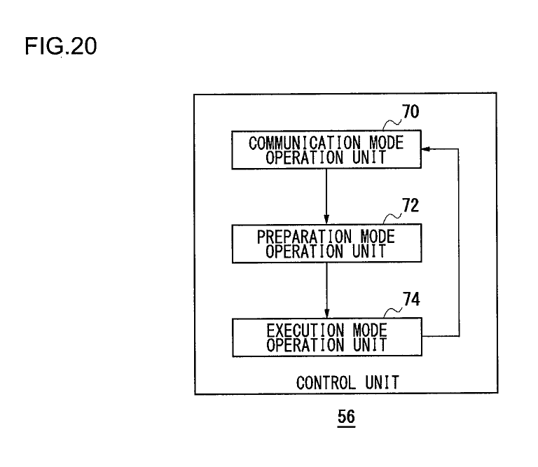

FIG. 20 shows the configuration of the control unit 56. The control unit 56 includes a communication mode operation unit 70, a preparation mode operation unit 72, and an execution mode operation unit 74. The communication mode operation unit 70 executes the communication mode for the operation of the vehicle camera apparatus 90. In the communication mode, the wireless unit 50 through the processing unit 54 communicate with the terminal apparatus 10. Giving a detailed description, the communication mode operation unit 70 outputs the image data received from the coding unit 58 and transmits the image data to the processing unit 54 through the wireless unit 50.

The communication mode is set even when the actual communication is not taking place. The communication mode operation unit 70 receives, via the wireless unit 50 through the processing unit 54, the preparation-mode-transition instruction signal from the terminal apparatus 10 for which the setting related to the wireless network with the vehicle camera apparatus 90 is not made. As previously described, the preparation-mode-transition instruction signal corresponds to the request for the transition into the preparation mode for preparing the setting. The communication mode operation unit 70 outputs the received preparation-mode-transition instruction signal to the preparation mode operation unit 72.

The preparation mode operation unit 72 receives the preparation-mode-transition instruction signal from the communication mode operation unit 70. The preparation mode operation unit 72 checks whether there is any apparatus to be connected with. Giving a detailed description, the preparation mode operation unit 72 gives notification of a probe request via the processing unit 54 through the wireless unit 50. The preparation mode operation unit 72 determines that there is an apparatus to be connected with when the preparation mode operation unit 72 receives a probe response within a predetermined period of time via the wireless unit 50 through the processing unit 54. The preparation mode operation unit 72 transitions into the preparation mode in accordance with the preparation-mode-transition instruction signal when there is no apparatus to be connected with. The preparation mode can transition into the execution mode that is described hereinafter.

The preparation-mode-transition instruction signal includes the information for identifying the terminal apparatus 10, which is a source, and the preparation mode operation unit 72 stores the information in the control unit 56 (not shown). After transitioning into the preparation mode, the preparation mode operation unit 72 receives the setting request signal from the terminal apparatus 10 via the wireless unit 50 through the processing unit 54. The preparation mode operation unit 72 outputs the received setting request signal to the execution mode operation unit 74. When the preparation mode operation unit 72 does not receive the setting request signal within a predetermined period of time after it enters into the preparation mode, the preparation mode operation unit 72 allows the communication mode operation unit 70 to return to the communication mode. On the other hand, when there is an apparatus to be connected with, the preparation mode operation unit 72 keeps the communication mode operation unit 70 to stay in the communication mode, without following the preparation-mode-transition instruction signal.

The execution mode operation unit 74 receives a setting request signal from the preparation mode operation unit 72. After that, the execution mode operation unit 74 transitions into the execution mode. The execution mode is for performing the setting related to a wireless network among the terminal apparatuses 10. The execution mode operation unit 74 performs the setting related to the wireless network among the terminal apparatuses 10 by transitioning into the execution mode. The setting request signal includes the information for identifying the terminal apparatus 10, which is a source, in the same way the preparation-mode-transition instruction signal does.

The execution mode operation unit 74 transitions into the execution mode when the information stored in the control unit 56 and the information included in the setting request signal are the same. This corresponds to the transition into the execution mode when the terminal apparatus 10 that has transmitted the request for transitioning into the preparation mode and the terminal apparatus 10 that has transmitted the setting request are the same. On the other hand, the execution mode operation unit 74 rejects the transition into the execution mode when the both sets of information are not the same. When being in the communication mode, the execution mode operation unit 74 rejects the transition into the execution mode even when it has received the setting request signal from the terminal apparatus 10 and keeps the communication mode operation unit 70 from leaving the communication mode. After performing the setting in the execution mode operation unit 74, the communication mode operation unit 70 communicates with the terminal apparatus 10 by transitioning into the communication mode.

In such a configuration, a vehicle camera apparatus 90 not provided with an interface for receiving an instruction for starting, in other words, a vehicle camera apparatus 90 not provided with the operation unit 22 is selected as a registrar from the terminal apparatuses 10 and the vehicle camera apparatus 90 that are included in the communication system 100. Upon the detection of the departure of the vehicle camera apparatus 90 assigned to be the registrar, the control unit 18 or the control unit 56 gives notification of a signal including information regarding the attribute (hereinafter, referred to as “attribute information”). The attribute information indicates whether or not the operation unit 22 is included and thus corresponds to information indicating whether or not the control unit belongs to a terminal apparatus 10 or to a vehicle camera apparatus 90.

Upon the receipt of the attribute information, other control units 18 or other control units 56 generate their own attribute information and give notification of the generated attribute information. By the above-stated processes, the terminal apparatuses 10 and the vehicle camera apparatuses 90 in the communication system 100 exchange their attribute information with one another. The control unit 18 and the control unit 56 identify the vehicle camera apparatus 90 as a registrar by referring to the attribute information. When there are multiple vehicle camera apparatuses 90, one vehicle camera apparatus 90 needs to be selected as a registrar by using the techniques that have been previously described. In order for the terminal apparatuses 10 and the vehicle camera apparatuses 90 to commonly recognize the registrar, the vehicle camera apparatus 90 identifying itself as the registrar may give notification indicating that the vehicle camera apparatus 90 is the registrar.

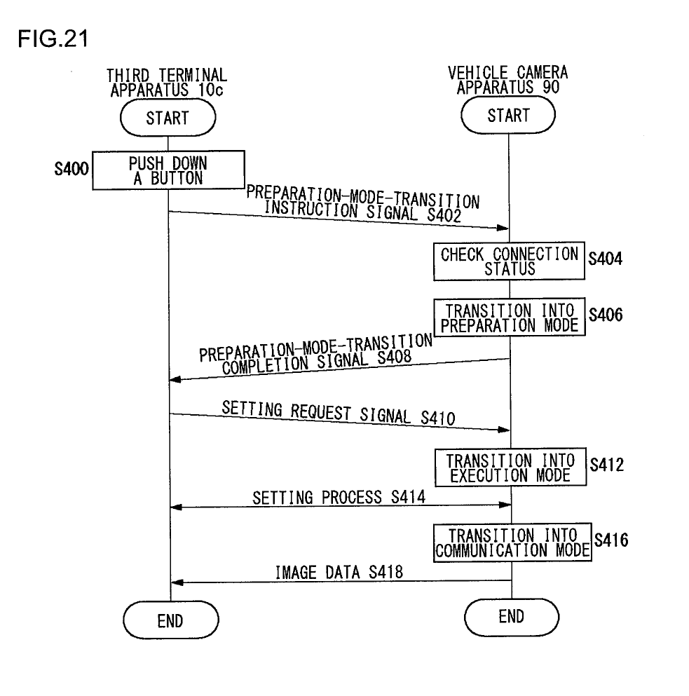

FIG. 21 is a sequence diagram illustrating a setting procedure in the communication system 100 according to yet another exemplary variation of the present invention. The third terminal apparatus 10c shown in FIG. 1 is assumed to be a vehicle monitor apparatus. The third terminal apparatus 10c detects a push of a button (S400). The third terminal apparatus 10c gives notification indicating a preparation-mode-transition instruction signal (S402). The vehicle camera apparatus 90 checks the connection status (S404) and transitions into the preparation mode (S406). The vehicle camera apparatus 90 transmits a preparation-mode-transition completion signal to the third terminal apparatus 10c (S408). The third terminal apparatus 10c transmits a setting request signal to the vehicle camera apparatus 90 (S410). Upon the receipt of the setting request signal, the vehicle camera apparatus 90 transitions into the execution mode (S412). After this, the vehicle camera apparatus 90 and the third terminal apparatus 10c perform a setting process (S414). After the completion of the setting process, the vehicle camera apparatus 90 transitions into the communication mode (S416). The vehicle camera apparatus 90 transmits image data to the third terminal apparatus 10c (S418).

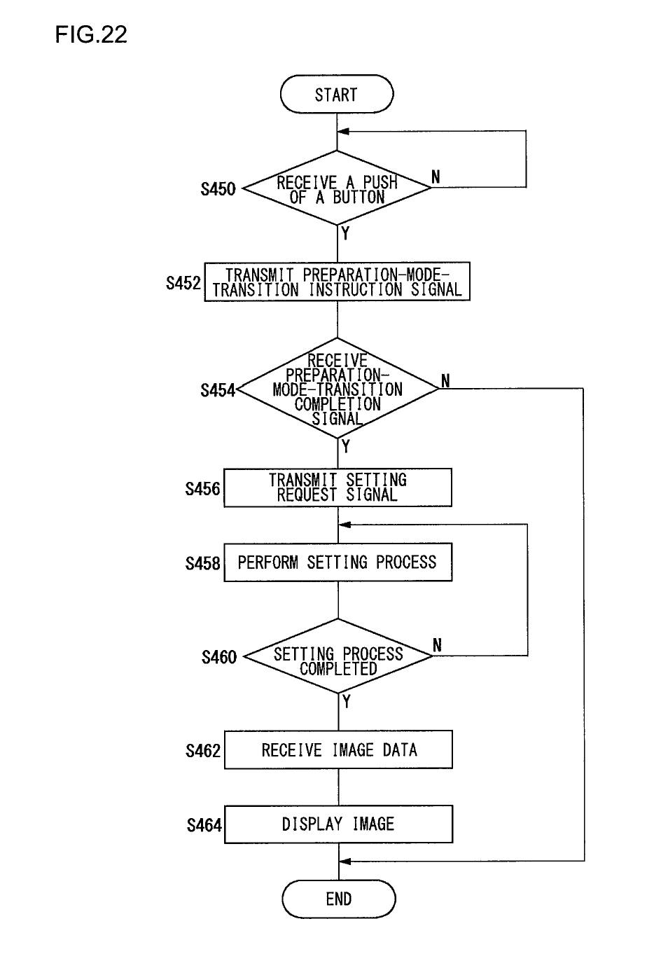

FIG. 22 is a flowchart illustrating a setting procedure in a terminal apparatus 10 according to yet another exemplary variation of the present invention. The operation unit 22 is on stand-by when it does not receive any push of the button (N in S450). When the operation unit 22 receives the push of the button (Y in S450), the request unit 40 transmits a preparation-mode-transition instruction signal via the processing unit 16 through the wireless unit 12 (S452). Upon the receipt of the preparation-mode-transition completion signal via the wireless unit 12 through the processing unit 16 (Y in S454), the checking unit 42 transmits a setting request signal via the processing unit 16 through the wireless unit 12 (S456). After this, the execution unit 44 performs a setting process (S458). If the setting process is not completed (N in S460), the step goes back to Step S458. When the setting process is completed (Y in S460), the wireless unit 12 through the processing unit 16 all receive image data (S462). The processing unit 16 decodes the image data, and the monitor 24 displays the image (S464). On the other hand, when the checking unit 42 does not receive the preparation-mode-transition completion signal via the wireless unit 12 through the processing unit 16 (N in S454), the process is terminated.

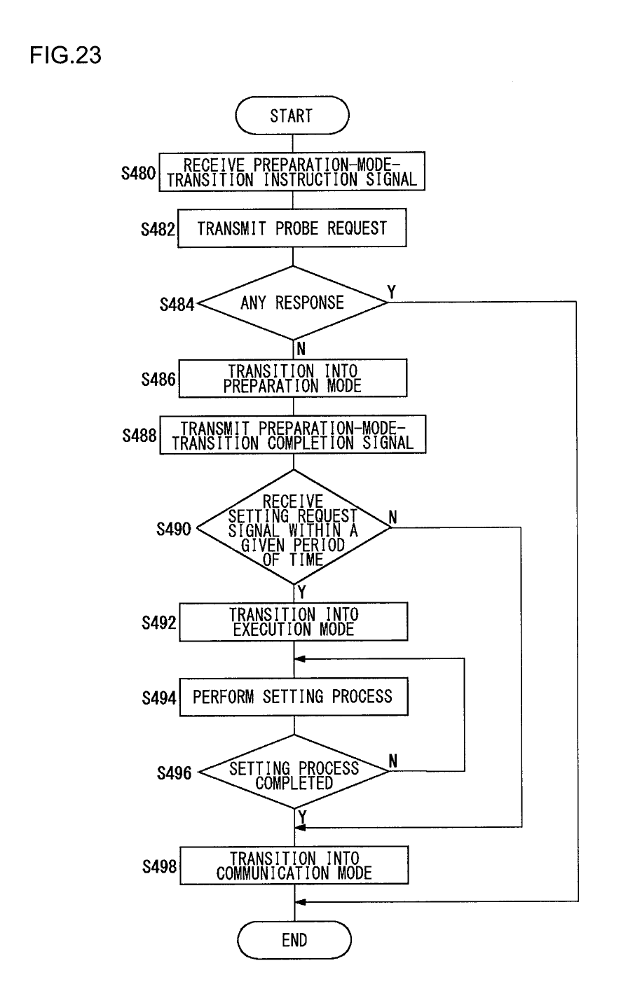

FIG. 23 is a flowchart illustrating a setting procedure in the vehicle camera apparatus 90. The communication mode operation unit 70 receives a preparation-mode-transition instruction signal via the wireless unit 50 through the processing unit 54 (S480). The preparation mode operation unit 72 transmits a probe request via the processing unit 54 through the wireless unit 50 (S482). The preparation mode operation unit 72 transitions into the preparation mode (S486), when there is no response (N in S484). The preparation mode operation unit 72 transmits a preparation-mode-transition completion signal via the processing unit 54 through the wireless unit 50 (S488). When the preparation mode operation unit 72 receives a setting request signal within a given period of time via the wireless unit 50 through the processing unit 54 (Y in S490), the execution mode operation unit 74 transitions into the execution mode (S492).

The execution unit 74 performs a setting process (S494). If the setting process is not completed (N in S496), the step goes back to Step S494. When the setting process is completed (Y in S496), the communication mode operation unit 70 transitions into the communication mode (S498). When the preparation mode operation unit 72 does not receive a setting request signal within a given period of time via the wireless unit 50 through the processing unit 54 (N in S490), the communication mode operation unit 70 transitions into the communication mode (S498). When there is a response mode (Y in S484), the preparation mode operation unit 72 keeps the communication mode operation unit 70 from leaving the communication mode and completes the process.

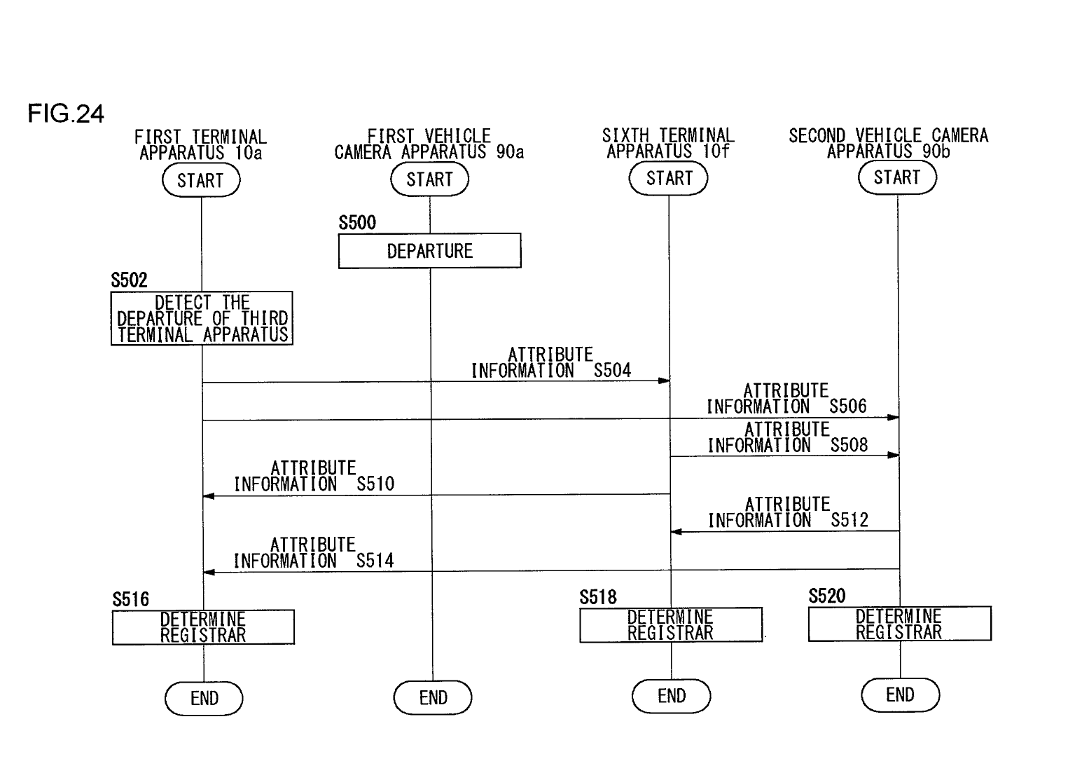

FIG. 24 is a sequence diagram illustrating a modification procedure of a registrar in the communication system 100 according to yet another exemplary variation of the present invention. A first vehicle camera apparatus 90a is assumed to be a registrar. The first vehicle camera apparatus 90a leaves the communication system 100 (S500). Upon the detection of the departure of the first vehicle camera apparatus 90a (S502), the first terminal apparatus 10a gives notification of the attribute information (S504 and S506). Upon the receipt of the attribute information, the sixth terminal apparatus 10f gives notification of its attribute information (S508 and S510); upon the receipt of the attribute information, a second vehicle camera apparatus 90b also gives notification of its attribute information (S512 and S514). The first terminal apparatus 10a, the sixth terminal apparatus 10f, and the second vehicle camera apparatus 90b all determine the registrar based on the attribute information (S516, S518, and S520).

According to the exemplary embodiment of the present invention, the role of a registrar can be switched among multiple terminal apparatuses, and an approval process can be thus performed even when the configuration of a communication network changes. Even when the terminal apparatus that is assigned to be the registrar leaves the communication system, another terminal apparatus is assigned to be the registrar. Thus, the connecting process of a new terminal apparatus can be performed. Since another terminal apparatus is assigned to be the registrar, the lowering of security can be suppressed. Since a new registrar is automatically selected, user-friendliness can be improved. Also, since the terminal apparatus with a long participation period of time in the communication system can be selected, a terminal apparatus that is expected to participate in the communication system in the future can be selected, allowing for the maintenance of the stability of the communication system.

Since a terminal apparatus that has received notification signals transmitted from a large number of terminal apparatuses is selected as the registrar, a terminal apparatus that can easily communicate with other terminal apparatuses in a direct manner can be selected. Since a terminal apparatus with a high processing speed is selected as the registrar, the connecting process can be promptly performed. Since a terminal apparatus that has detected the departure of the terminal apparatus that is assigned to be the registrar is selected as a registrar, the switching of the registrar can be promptly performed.

Since a terminal apparatus that has high average received power is selected as the registrar, a terminal apparatus that can easily communicate with other terminal apparatuses in a direct manner can be selected. Since a terminal apparatus that has high value of the lowest received power is selected as the registrar, the degradation of communication quality can be suppressed. Since a terminal apparatus that has a low error rate is selected as the registrar, a terminal apparatus with high communication quality can be selected. Since a terminal apparatus that has a low moving speed is selected as the registrar, a terminal apparatus with stabilized communication quality can be selected. Since a terminal apparatus not provided with an interface is selected as a registrar, a vehicle camera apparatus provided with an interface and a terminal apparatus provided with an interface can be connected. Since a current registrar sets the subsequent registrar, a registrar can be set without fail. Since a request signal is transferred to a new registrar when the original registrar receives the request signal, an approval process can be performed even when there are multiple registrars.

Described above is an explanation based on the exemplary embodiments of the present invention. These exemplary embodiments are intended to be illustrative only, and it will be obvious to those skilled in the art that various modifications to constituting elements and processes could be developed and that such modifications are also within the scope of the present invention.

In the exemplary embodiment of the present invention, the terminal apparatus 10 performs both the connection process and the transfer process while using the same wireless unit 12 and the modem unit 14. In other words, the both processes are performed while using a wireless LAN. However, the embodiment is not limited to this example. For example, another wireless unit 12 and modem unit 14 may be used for the connection process and the transfer process. In other words, while a wireless LAN is used for the transfer process, another communication system may be used for the connection process, or vice versa. The exemplary embodiments allow the degree of freedom of the configuration of a communication system to be improved.

In the exemplary embodiment of the present invention, a terminal apparatus that has participated in the communication system 100 for a long time is selected as a registrar. However, the embodiment is not limited to this example. For example, a terminal apparatus that has started the communication system 100 may be selected as a registrar. The exemplary variations allow for the easy selection of a registrar. The control unit 18 may select a terminal apparatus 10, which has newly joined the communication system 100, to be a registrar. According to the exemplary variation, the control unit 18 selects a terminal apparatus 10 expected to participate in the communication system 100 for a long time to be a registrar, allowing for the improvement of the stability of the communication system.

In the exemplary embodiment of the present invention, the control unit 18 selects a terminal apparatus 10 with a large number of apparatuses as a registrar. However, the embodiment is not limited to this example. For example, the control unit 18 may select a terminal apparatus 10 with a less number of terminal apparatuses as a registrar. The exemplary variation allows a terminal apparatus 10 existing at the end of the area of the communication system 100 to be selected as a registrar.

In the exemplary embodiment of the present invention, the control unit 18 selects a terminal apparatus 10 with a high processing speed as a registrar. However, the embodiment is not limited to this example. For example, the control unit 18 may select as a registrar a terminal apparatus 10 with high reception sensitivity. The exemplary variation allows the reception probability of a request signal from the terminal apparatus 10 of the requestor to be improved.

In the exemplary embodiment of the present invention, the control unit 18 performs a process for selecting a new registrar by using the departure of a terminal apparatus 10 assigned to be a registrar as a trigger. However, the embodiment is not limited to this example. For example, the control unit 18 may periodically perform the process for selecting a new registrar. The exemplary variation allows for the selection of a registrar so that a change in the configuration of the communication system 100 is followed.

In the exemplary embodiment of the present invention, the control unit 18 selects a registrar based on the number of terminal apparatuses or on the received power. However, the embodiment is not limited to this example. For example, a terminal apparatus 10 may have a positioning function by a GPS, and a terminal apparatus 10 that is close to the center position may be selected as a registrar after exchanging information of measured position among multiple terminal apparatuses 10. The exemplary variation allows a terminal apparatus that can easily communicate with other terminal apparatuses in a direct manner to be selected.

In the exemplary embodiment of the present invention, when there are both a terminal apparatus 10 and a vehicle camera apparatus 90, the vehicle camera apparatus 90 is selected as a registrar. However, the embodiment is not limited to this example. For example, a terminal apparatus 10 may be selected as a registrar. In this case, a vehicle camera apparatus 90 transmits a request signal to the terminal apparatus 10 after the transition into the execution mode. The exemplary variation allows for the connection between a terminal apparatus 10 and a vehicle camera apparatus 90.

### INDUSTRIAL APPLICABILITY

According to the present invention, an approval process can be performed even when the configuration of an ad hoc network changes.

1. A communication method comprising:
selecting, in an ad hoc network formed by a plurality of terminal apparatuses, any one of the plurality of terminal apparatuses to have the role of approving the participation of a new terminal apparatus in the ad hoc network;
approving the participation of a new terminal apparatus by the selected terminal apparatus; and
communicating in the ad hoc network including the new terminal apparatus approved to participate, wherein
in selecting any one of the plurality of terminal apparatuses, a terminal apparatus to be selected is switched among the plurality of terminal apparatuses.

2. The communication method according to claim 1 wherein, in selecting any one of the plurality of terminal apparatuses, a terminal apparatus that has started the ad hoc network is selected.

3. The communication method according to claim 1 wherein, in selecting any one of the plurality of terminal apparatuses, a terminal apparatus that has participated in the ad hoc network for a long time is selected.

4. The communication method according to claim 1 wherein
in communicating, each one of the plurality of terminal apparatuses gives notification of a signal indicating the existence thereof, and each one of the plurality of terminal apparatuses receives the signals as notified by other terminal apparatuses, and
in selecting any one of the plurality of terminal apparatuses, the number of other terminal apparatuses that have given notification of received signals is calculated for each terminal apparatus, and a terminal apparatus with a large calculated number is selected.

5. The communication method according to claim 1 wherein
in communicating, each one of the plurality of terminal apparatuses gives notification of a signal indicating the existence thereof, and each one of the plurality of terminal apparatuses receives the signals as notified by other terminal apparatuses, and
in selecting any one of the plurality of terminal apparatuses, the number of other terminal apparatuses that have given notification of received signals is calculated for each terminal apparatus, and a terminal apparatus with a small calculated number is selected.

6. The communication method according to claim 1 wherein
in communicating, each one of the plurality of terminal apparatuses gives notification of a signal indicating the existence thereof, and each one of the plurality of terminal apparatuses receives the signals as notified of by other terminal apparatuses, and
in selecting any one of the plurality of terminal apparatuses, at least one terminal apparatus is selected according to a quality of a received signal.

7. The communication method according to claim 1 wherein
in communicating, each one of the plurality of terminal apparatuses gives notification of information regarding processing speed, and
in selecting any one of the plurality of terminal apparatuses, a terminal apparatus having a high processing speed is selected.

8. The communication method according to claim 1 wherein
in communicating, each one of the plurality of terminal apparatuses gives notification of information regarding reception sensitivity, and
in selecting any one of the plurality of terminal apparatuses, a terminal apparatus having high reception sensitivity is selected.

9. The communication method according to claim 1 wherein, in selecting any one of the plurality of terminal apparatuses, a terminal apparatus that has newly participated in the ad hoc network is selected.

10. The communication method according to claim 1 wherein, in selecting any one of the plurality of terminal apparatuses, a terminal apparatus that has detected the departure of an already-selected terminal apparatus from the ad hoc network is selected.

11. The communication method according to claim 1 wherein,
in communicating, each terminal apparatus derives its own moving speed and gives notification of the derived moving speed, and
in selecting any one of the plurality of terminal apparatuses, a terminal apparatus having a low moving speed is selected.

12. The communication method according to claim 1 including:
a first terminal apparatus provided with an interface for receiving an instruction for starting approving the participation from a user; and a second terminal apparatus provided with the interface, wherein
in selecting any one of the plurality of terminal apparatuses, the first terminal apparatus is selected.

13. The communication method according to claim 1 wherein, in selecting any one of the plurality of terminal apparatuses, a terminal apparatus specified by an already-selected terminal apparatus is selected.

14. A communication system comprising:
a plurality of terminal apparatuses operative to communicate by forming an ad hoc network;
a new terminal apparatus operative to request participating in the ad hoc network formed by the plurality of terminal apparatuses, wherein
any one of the plurality of terminal apparatuses is selected to have the role of approving participation of a new terminal apparatus in the ad hoc network, and a terminal apparatus to be selected is switched among the plurality of terminal apparatuses.
